(19) United States
(12) Patent Application Publication
(10) Pub. No.: US 2017/0351653 A1
(43) Pub. Date: Dec. 7, 2017

(54) SYSTEM AND METHOD OF AGGREGATING NETWORKED DATA AND INTEGRATING POLLING DATA TO GENERATE ENTITY-SPECIFIC SCORING METRICS

(71) Applicant: Starting Block Capital, LLC, Washington, DC (US)

(72) Inventors: Michael RAMLET, Washington, DC (US); Alexander DULIN, Washington, DC (US); Kyle DROPP, Washington, DC (US)

(73) Assignee: Starting Block Capital, LLC, Washington, DC (US)

(21) Appl. No.: 15/615,484

(22) Filed: Jun. 6, 2017

Related U.S. Application Data
(60) Provisional application No. 62/346,481, filed on Jun. 6, 2016.

(51) Int. Cl. G06F 17/24; G06Q 30/02; G06F 3/0482; G06F 3/0484; G06T 11/60; G06T 11/20

(52) U.S. Cl. CPC G06F 17/241; G06T 11/60; G06T 11/206; G06F 3/0482; G06F 3/04842; G06Q 30/0245

(57) ABSTRACT

Various systems and methods may aggregate content from one or more poll results database/sources, social media platforms, content sites, and/or other sources. For polling data, each category of results may correspond to direct responses to polling questions. For example, a question may be posed to respondents “Do you have a favorable or unfavorable impression of <Entity>?” in which “<Entity>” corresponds to an entity for which a brand score is being generated. The responses may include the categories such as: “Very Favorable,” “Somewhat Favorable,” “Somewhat Unfavorable,” “Very Unfavorable,” “Never Heard Of,” “Heard Of, but No Opinion.” For non-polling data, the system may parse the content (e.g., words or phrases, graphics such as “emoji”, comments, etc.) to categorize the non-polling data into one of the above categories, which may correspond to a polling category. Brand scores may be generated based on the polling data and/or the non-polling data.

### RELATED APPLICATIONS

This application claims priority to U.S. Provisional Patent Application No. 62/346,481, filed on Jun. 6, 2016, entitled “System and Method of Aggregating Networked Data and Integrating Polling Data to Generate Entity-Specific Scoring Metrics” and is related to co-pending U.S. patent application Ser. No. 14/943,779, filed on Nov. 17, 20115, entitled “SYSTEM AND METHOD OF ANALYZING POLLING RESULTS AND GENERATING POLLING RESULTS OUTPUTS,” the contents of each of which are hereby incorporated by reference in their entireties.

### FIELD OF THE INVENTION

The invention relates to a system and method of aggregating networked data, such as data available via a network, and integrating polling data to generate entity-specific scoring metrics to generate a brand score for an entity.

### BACKGROUND OF THE INVENTION

Polls in which respondents provide a response, typically to a poll question, can provide valuable insight into the respondents' sentiment and thoughts relating to a poll topic, such as an entity. The poll question can be open-ended in which free-form responses are allowed or closed in which the respondent must select a response from among two or more choices (e.g., yes/no, excellent/good/average/below average/poor, etc.). Poll topics can be broad, such as “do you have a favorable view of entity X” to more specific, such as “what aspects of entity X do you like/dislike.”

Although valuable, poll results can present an incomplete view of users' perception of an entity. Although vast quantities of data from a wider range of users are available on public networks such as the Internet, conventionally, this information has been ignored because of the limitations in the way in which to aggregate and analyze the information (including polling information, social media information, regular media information, and/or other information) in a meaningful way.

These and other drawbacks exist with conventional brand metric systems.

### SUMMARY OF THE INVENTION

The invention relates to a system and method of aggregating networked data, such as data available via a network, and integrating polling data to generate entity-specific scoring metrics to generate a brand score for an entity.

In an implementation, the system may aggregate content from one or more sources such as, for example, one or more poll results database/sources, social media platforms, content sites, and/or other sources. To aggregate data from social media platforms, the system may aggregate interface with a API published by a corresponding social media platform. For example, the system may establish one or more types of communications with a social media platform, and format data (e.g., requests for content) to the social media provider using a communication protocol, which may be specified by the API.

To aggregate data from content sites, the system may subscribe to a news feeds (e.g., a Rich Site Summary feed), subscribe to and parse newsletters (which may be industry-specific newsletters for specific industries), read physical print media (which may be scanned by, for example, employees or others working on behalf of an operator of the system) using optical character recognition or other computer vision techniques, and/or otherwise obtain regular media (non-social media data which is generally although not necessarily user-generated for consumption by other users) data.

For polling data, each category of results may correspond to direct responses to polling questions. For example, a question may be posed to respondents “Do you have a favorable or unfavorable impression of <Entity>?” in which “<Entity>” corresponds to an entity for which a brand score is being generated. The responses may include the categories illustrated in Table 1, such as: “Very Favorable,” “Somewhat Favorable,” “Somewhat Unfavorable,” “Very Unfavorable,” “Never Heard Of,” “Heard Of, but No Opinion.” Other types of poll responses may correspond to other categories as well. Each category of results may correspond to a number of respondents who provided an answer corresponding to that category. The polling data may be obtained from polling system 101, as described herein elsewhere.

For non-polling data, which may not be directly categorized (e.g., social media and regular media data), the system may further analyze the content to place the content into one of the above categories of results. For example, and without limitation, the system may perform the following analysis on social media content items (e.g., social media posts), regular media content items (e.g., news articles), and/or other types of content that is not directly able to be categorized (unlike, for example, poll results data).

In an implementation, the system may parse the content (e.g., words or phrases, graphics such as “emoji”, comments such as comments to a news article, etc.) of the non-polling data to categorize the non-polling data. The system may obtain, from a content scoring database, content correlations to one or more values for determining an overall category of the non-polling data. For words or phrases, for example, the system may obtain, from the content scoring database, a predefined dictionary that maps words or phrases to positive, negative, or neutral values. In some instances, the positive, negative, or neutral values may correspond to a quantitative score (e.g., 10 for the highest positive and −10 for the lowest negative). The predefined dictionary may be specified by an administrator (e.g., a user who maintains the system), and may be updated to add, remove, or replace the content of the dictionary.

In a particular example, various words or phrases (e.g., “great,” “awesome,” “dependable,” “high quality,” “integrity”) may correspond to relatively high positive values in the dictionary (and in some cases numeric scores such as 10). Other words or phrases (e.g., “good,” “OK,” “above average”) may correspond to less positive (but still positive) values in the dictionary (and in some cases numeric scores such as 7). Still other words or phrases (e.g., “terrible,” “low quality,” “untrustworthy”) may correspond to negative values in the dictionary (and in some cases numeric scores such as −10″). Still other words or phrases (e.g., “OK,” “average,” “so so”) may correspond to neutral opinions (and in some cases numeric scores such as 0″).

It should be noted that the dictionary of values may not be a full comprehensive set of words or phrases, and that known synonyms (including slang synonyms) may be used as well. Furthermore, in some instances, multiple languages may be accounted for by automatically detecting the original language and using an automatic language service (e.g., online or client-based language translation services) to automatically (e.g., without human intervention) translate the original language into a base language for processing. Alternatively or additionally, the system may compare the foreign language (foreign being relative to a base language used by the system) to different dictionaries stored in the content scoring database, each dictionary corresponding to a different foreign language.

Similar to parsing and assigning values to words or phrases, the system may analyze emojis and similar graphical objects that may be embedded within the content (e.g., social media content or regular media content). For example, depending on the system from which the content was obtained, each emoji may be encoded using a particular identification, which corresponds to a particular graphic (e.g., a thumbs up or down graphic, a smiley face graphic, etc.) to be displayed. The content scoring database may store the emoji identifications in association with positive or negative values (e.g., values similar to those described above with respect to the words or phrases).

Once the content is parsed (or otherwise read) by the system, the number of content matches to the dictionary (and their corresponding values) may be determined. For example, the system may determine characterize a given piece of non-polling data as being “very favorable” or other category of results. To do so, in one implementation, the system may count the number of different types of word or phrase or emoji matches to the dictionary. For example, for a given social media post, the system may count the number of “high positive” matches, “less positive” matches, “average” matches, and “negative” matches. Other types of matches may be counted as well (such as a different numbers of positive or negative matches).

Based on the number of types of matches for a given social media post, the system may determine that the post had a “Very Favorable” sentiment or other types of sentiment. For example, the system may determine that the post had a very favorable sentiment if a certain percentage of matches (e.g., 70 and above) were high positive matches, a somewhat favorable sentiment if a certain percentage of matches (e.g., 20 to 70) were high positive matches or if a certain percentage of a total of less positive matches and high positive matches exceeds a certain percentage such as 70). Likewise, negative sentiments may be determined based on certain percentages of matches to negative matches. Neutral sentiments may be determined when neither positive or negative matches exceeds a requisite threshold or when average matches exceeds a certain percentage threshold. These thresholds may be initially system by an administrator or other users, and may be updated from time to time.

Once each of the non-polling data items have been characterized, the system may count the number of each type of characterization and place the count in a corresponding category of results. For example, the number of content items having a “Very Favorable” sentiment, “Somewhat Favorable” sentiment, “Somewhat Unfavorable” sentiment, “Very Unfavorable” sentiment, and “Heard Of, but No Opinion” (e.g., average) sentiment may be counted.

In an implementation, once the different types of data have been analyzed and characterized as described above, the system may generate a brand score for an entity based on the analysis. To generate the brand score, the system may generate a sub-score for each type of data (and an overall brand score based on one or more of the sub-scores). For example, the system may generate a sub-score for the polling data, and a sub-score for each of the different types of non-polling data. The sub-score may be expressed as a letter grade (e.g., A+, A, A−, B+, B, B−, C+, C, C−, D+, D, D−, F, etc.). Other types of scoring representations may be used as well.

Generally speaking, the system may generate a sub-score based on the numbers of different categories of results for a given type of aggregated data. For example, and without limitation, the system may determine a number of polling responses of each of “Very Favorable,” “Somewhat Favorable,” “Somewhat Unfavorable,” “Very Unfavorable,” “Never Heard Of,” “Heard Of, but No Opinion” for polling data. Likewise, the system may determine a number of social media posts that were categorized into each of “Very Favorable,” “Somewhat Favorable,” “Somewhat Unfavorable,” “Very Unfavorable,” “Never Heard Of,” “Heard Of, but No Opinion” for social media data. Still likewise, the system may determine a number of media articles that were categorized into each of “Very Favorable,” “Somewhat Favorable,” “Somewhat Unfavorable,” “Very Unfavorable,” “Never Heard Of,” “Heard Of, but No Opinion” for regular media data.

For each of the types of aggregated data, the system may compare the above results to a group of entities similar to the entity to be scored. “Similar entities” may include competitors (e.g., competing companies, competing products, opposing politicians in an election, individuals in the same profession such as professional athletes, entertainment celebrities, etc.), entities sharing some other characteristic (e.g., companies in a Fortune® 100 list, companies on a stock index such as the S&P 500®, etc.). In this sense, each sub-score may be a relative score in that entities having the most number of “Favorable” results will have higher scores relative to entities having a lower number of “Favorable” results.

In a particular implementation, the system may determine the overall number of “Favorable” results (e.g., sum of “Very Favorable” and “Somewhat Favorable” results) and the overall number of “Unfavorable” results (e.g., sum of “Somewhat Unfavorable” and “Very Unfavorable” results). “Never Heard of” and “Heard of, but no Opinion” results may be counted as an “Unfavorable” result, may be ignored, or may be used to generate an entirely different sub-score such as a recognition subscore. Once the different results have been counted, the system may generate a ratio of “Favorable” results to “Unfavorable” results and compare this ratio to the ratios of similar entities. For example, an entity having 50 Favorable results and 10 Unfavorable results will be assigned a ratio of 5. This ratio may be compared to the ratio of similar entities. The ratios may be plotted along a distribution graph such that different portions on the graph are assigned with a sub-score.

An entity may be assigned with a sub-score based on the entity's ratio position on the distribution graph. For example and without limitation, entities within the top 15% on the graph (e.g., the highest 15% of the ratios) will be given a score in the “A” range (with the top third getting an A+, middle third getting an A, and lower third of this range getting an A−). Likewise, the next 30% on the graph will be given a score in the “B” range (with the top third getting a B+, middle third getting a B, and lower third of this range getting a B−), the next 30% on the graph will be given a score in the “C” range (with the top third getting a C+, middle third getting a C, and lower third of this range getting a C−), the next 15% on the graph will be given a score in the “D” range (with the top third getting a D+, middle third getting a D, and lower third of this range getting a D−), and the bottom 10% on the graph will be given a score of “F.”

In some implementations, the system may determine a sub-score through other metrics as well. For example, the system may determine the sub-score based solely on the number of Favorable results. This number may be normalized by obtaining a percentage by dividing the number of Favorable results by the number of Unfavorable results. The percentage may be plotted on a distribution graph based on percentages of similar entities, and a sub-score may be assigned as discussed above with respect to the ratios.

In some implementations, the system may use the higher of the determined sub-scores. For instance, if an entity was assigned a B using the ratio metric, but was assigned an A− for the percentage metric, then the system select the A− for the sub-score. Of course, an average or other cumulative score (e.g., median) may be used as well. For averages, each letter grade sub-score may be converted to a quantitative value such as an integer or decimal. In a particular example, each letter grade may be converted to a corresponding quantitative value such that an A+ corresponds to a 100, an A corresponds to a 95, and an A− corresponds to a 90. Other letter grades may be similarly converted to numeric values (e.g., a B+corresponding to an 89, a B corresponding to an 85, and a B− corresponding to an 80, and so on).

In implementations for which only a single sub-score is used to generate an overall brand score for the entity, the sub-score will be used as the overall brand score. However, in implementations in which multiple sub-scores are used to generate the overall brand score, each sub-score may be converted to a quantitative value and a cumulative value based on each quantitative value may be determined.

In some implementations, the system may present the sub-scores (quantitative and/or letter), overall brand score (quantitative and/or letter), and/or other information when presenting the scores. In some instances, the system may present one or more selectable options that cause one or more of the types of data to be weighted, or weighted differently, to achieve an overall brand score. In this manner, users may be able to fine-tune their own brand scores according to their needs. Alternatively or additionally, the system may enable each user to predefine the weights so that they are provided with customized brand scores. In either of the foregoing instances, the system may generate a generic score with system-defined defaults that are used to provide brand scores in a consistent manner, irrespective of any user-defined settings. In this manner, the system may maintain consistent scoring metrics (or at least store indications of how a given score was generated—e.g., the types of data used and any weights that were applied).

In some implementations, the system may periodically generate a brand score so that any updates in sentiment may be captured. The system may also or instead periodically update an overall sector score (which may be an average or other cumulative score) based on brand scores for entities in a given sector (e.g., home improvement retailers), and/or an overall industry score (which may be an average or other cumulative score) based on brand scores for entities in a given industry (e.g., all retailers).

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system for processing poll results relating to an entity, obtaining extra-poll data, such as social media and regular media content, and generating entity metrics

FIG. 2 illustrates a polling analytics computer system for analyzing poll results and generating poll results outputs, according to an implementation of the invention.

FIG. 3 illustrates a flow diagram of a process for analyzing poll results and generating poll results outputs, according to an implementation of the invention.

FIG. 4 illustrates a flow diagram of a process for generating a display of secondary information overlaid onto poll results, according to an implementation of the invention.

FIG. 5 illustrates a flow diagram of a process for dynamically updating a display of poll results based on parameter parameters, according to an implementation of the invention.

FIG. 6 illustrates a flow diagram of a process for dynamically generating a slide document based on selectable polls, according to an implementation of the invention.

FIG. 7A illustrates a channel through which the poll results output may be presented to a user, according to an implementation of the invention.

FIG. 7B illustrates a channel through which the poll results output may be presented to a user, according to an implementation of the invention.

FIG. 8 illustrates a screenshot of a user interface for providing selectable poll topics, according to an implementation of the invention.

FIG. 9 illustrates a screenshot of a user interface for providing a display mode of a poll results output, according to an implementation of the invention.

FIG. 10 illustrates a screenshot of a user interface for providing a display mode of a poll results output based on respondent characteristics, according to an implementation of the invention.

FIG. 11 illustrates a screenshot of a user interface for providing a chart display mode for providing a poll results output, according to an implementation of the invention.

FIG. 12 illustrates a screenshot of a user interface for providing a map display mode for providing a poll results output, according to an implementation of the invention.

FIG. 13 illustrates a screenshot of a user interface for generating slide documents that include poll result outputs, according to an implementation of the invention.

FIG. 14 illustrates a screenshot of a user interface for displaying company brand scores, according to an implementation of the invention.

FIG. 15 illustrates a screenshot of a user interface for displaying politician brand scores, according to an implementation of the invention.

FIG. 16 illustrates a screenshot of a user interface for displaying a detailed dashboard for an entity, according to an implementation of the invention.

FIG. 17 illustrates a flow diagram of a process for generating a brand score, according to an implementation of the invention.

FIG. 18 illustrates a flow diagram of a process for generating a sub-score for a type of aggregated data used in a brand score, according to an implementation of the invention.

### DETAILED DESCRIPTION OF THE INVENTION

The system and method relate to aggregating networked data, such as data available via a network, and integrating polling data to generate entity-specific scoring metrics to generate a brand score for an entity. An entity may include, without limitation, a company, an item such as a company's product or service, an individual (e.g., a politician, a celebrity, etc.), and/or other organization, person, or object for which an entity-specific score may be generated as described herein. The entity-specific score may be a “brand score” in various examples described herein. A given brand score may be based on a unique set of metrics, depending on the type of entity to which the brand score relates. In other instances, a brand score may be based on a universal set of metrics irrespective of the type of entity to which the brand score relates. In either instance, the systems and methods described herein may be used to generate brand scores relating to entities and generate various interfaces for displaying the brand scores and metrics.

Exemplary System Architecture

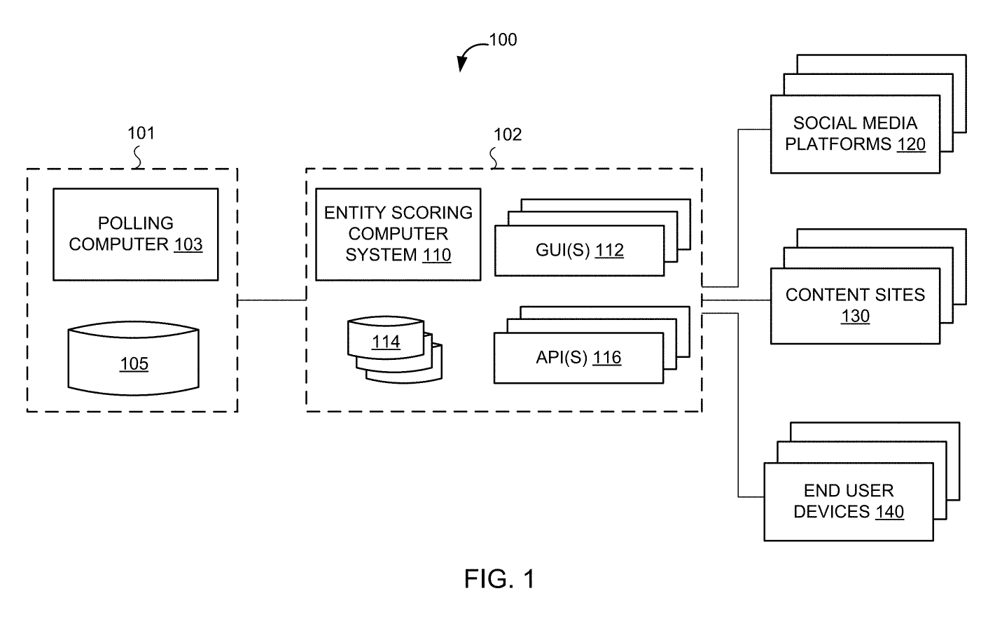

FIG. 1 illustrates a system 100 for processing poll results relating to an entity, obtaining extra-poll data, such as social media and regular media content, and generating entity metrics, according to an implementation of the invention. In an implementation, system 100 may include a polling system 101, a polling analytics system 102, one or more social media platforms 120, one or more content sites 130, one or more end user devices 140, and/or other components.

Polling system 101 may include a polling computer 103, a poll database 105, and/or other components. Polling computer 103 may be used to conduct polls and store the results of such polls using poll database 105. In some instances, the polls may be conducted through live-operators who ask poll questions to respondents and enter responses through their own computers, which communicate the responses to polling computer 103. In other instances, the polls may be conducted automatically, through the use of online forms (e.g., websites through which questions may be posed and responses collected), telephone (e.g., Interactive Voice Response systems), and/or other automated or semi-automated systems through which poll responses are provided to polling computer 103. Whichever manner is used to conduct a poll, polling computer 103 may store the responses in poll database 105.

In some instances, polling computer 103 may also store, in poll database 105, one or more characteristics of the respondents, if such characteristics are known. The characteristics may include, without limitation, an age, ethnicity, gender, residence address (locality, country, etc.), political party affiliation, religion, income, and/or other characteristics. Polling computer 103 may be aware of the characteristics before poll questions are posed to the respondent (e.g., when the respondent is already known to polling computer 103) or afterward (e.g., when the respondent is prompted to provide one or more characteristics). Of course, some characteristics may be known beforehand while others are discovered afterward. In any event, polling computer 103 may store an association of each of the characteristics of a respondent in a respondent profile so that a given respondent's characteristics may be looked up. Alternatively or additionally, each response to a poll question may be stored in association with information that identifies the respondent and/or the characteristics of the respondent. In this manner, each response may be stored in association with a demographic or other characteristic of the respondent who provided the response. Polling computer 103 may store the associations in poll database 105.

Polling analytics system 102 may obtain poll results from polling system 101 to analyze the poll results as described herein. The poll results may be pushed to or pulled by polling analytics system 102. In addition, in some instances, polling analytics system 102 may request certain polls to be conducted by polling system 101. In these instances, polling analytics system 102 may generate a polling specification that includes one or more polling parameters used to specify poll questions to be asked (e.g., questions and multiple-choice answers or open-ended answers), one or more respondent parameters that seek particular target respondents (e.g., age, gender, etc., of target respondents), and/or other parameters. Polling system 101 may then conduct the requested poll in response to and based on the polling specification and provide (or make available) the poll results, which may be analyzed by polling analytics system 102.

In some instances, polling analytics system 102 may provide analyzed poll results to social media platforms 120. Such platforms may include, without limitation, FACEBOOK, TWITTER, INSTAGRAM, YOUTUBE, and/or other social networks that generally provide user-generated content for consumption by other users. Alternatively, or additionally, polling analytics system 102 may provide analyzed poll results to content sites 130 that provide the analyzed poll results typically with other content. Such content sites may include news sites, weather sites, sports-related sites, shopping/electronic commerce sites, search engine sites, multimedia entertainment providers (e.g., video services), and/or other sites.

The third party platforms (e.g., social media platforms 120, content sites 130, etc.) may incorporate the poll result outputs into their respective assets. For instance, a news organization may incorporate a poll result output generated by polling analytics system 102 on its news website. Users or others (including organizations) may post certain poll result outputs directly to their social media account/homepage. Shopping sites may provide poll result outputs alongside reviews or other product information. Search engines may provide poll result outputs alongside search results to indicate users' indications of relevance of certain search results corresponding to certain search terms (as indicated by poll results, for example). Other examples of uses of the system will be apparent to those having skill in the art as well, based on the disclosure provided herein.

In some implementations, analyzed poll results may be accessed by end users using end user devices 140. For instance, users may obtain poll result outputs, then view and/or save them locally to their end user devices 140 (e.g., via GUIs 112 generated by polling analytics computer system 110), generate presentation documents that include poll results, post poll result outputs to their social media accounts using end user devices 140, and/or otherwise interact with the system using end user devices 140. The analyzed polling results and/or the polling results themselves may be stored in one or more databases, such as database(s) 114.

In an implementation, Application Programming Interfaces (APIs) 116 may include various APIs for use by third parties (e.g., social media platforms 120, content sites 130, etc.) to request different poll result outputs from polling analytics system 102. In these instances, polling analytics system 102 may expose external APIs 116 for use by third parties to access/request poll result outputs provided by polling analytics system 102. In this manner, such third parties may request and obtain poll result outputs for inclusion into their respective sites.

In an implementations, some APIs 116 may be used internally to access and interface with third parties. For instance, APIs 116 may be used to provide content to user's social media accounts. In this instance, polling analytics system 101 may obtain a user's credentials and authorization to post content to the user's social media account. Alternatively, polling analytics system 101 may use a given social media platform's API to facilitate logging into the user's social media account. In other examples, some APIs 116 may obtain data from third party sites, such as various social media platforms 120, content sites 130, and/or other third party sites. In this manner, the system may aggregate diverse networked data from various network resources to analyze a given entity and provide, for example, and entity specific score.

In an implementation, some of the foregoing APIs 116 may include various rules for formatting content. For instance, a given social media site may take images in a particular format while another site may take images in another format. APIs 116 may store rules that specify which format should be provided for a given recipient (whether the recipient is a user, an entity, a third party platform such as a social media platform 120, content site 130, etc.).

Having described a high level overview of the system, attention will now be turned to a description of polling analytics computer system 110.

Analyzing Poll Results and Generating Poll Result Outputs

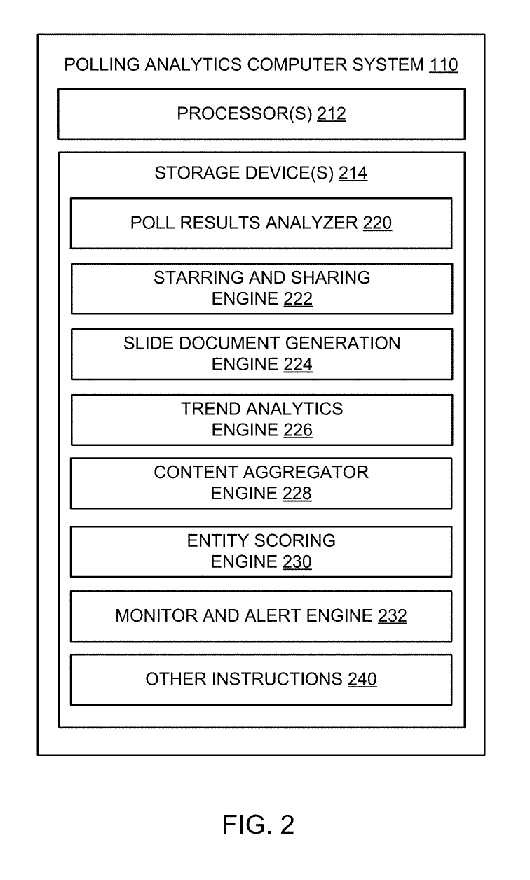

FIG. 2 illustrates a polling analytics computer system 110 for analyzing poll results and generating poll results outputs, according to an implementation of the invention. Polling analytics computer system 110 may be configured as a server (e.g., having one or more server blades, processors, etc.), a personal computer (e.g., a desktop computer, a laptop computer, etc.), and/or other device that can be programmed to analyze and provide poll results.

Polling analytics computer system 110 may include one or more processors 212 (also interchangeably referred to herein as processors 212, processor(s) 212, or processor 212 for convenience), one or more storage devices 214 (which may store various instructions described herein), and/or other components. Processors 212 may be programmed by one or more computer program instructions. For example, processors 212 may be programmed by a poll results analyzer 220, a starring and sharing engine 222, a slide document generation engine 224, a trend analytics engine 226, an Application Programming Interface (API) 228, and/or or other instructions 230 that program polling analytics computer system 110 to perform various operations, each of which are described in greater detail herein. As used herein, for convenience, the various instructions will be described as performing an operation, when, in fact, the various instructions program the processors 212 (and therefore computer system 110) to perform the operation.

In an implementation, poll results analyzer 220 may access the poll results and generate one or more poll result outputs. Poll results analyzer 220 may access and analyze the poll results either on-demand (e.g., when a user wishes to analyze and view poll results) or automatically access and analyze the poll results without being specifically requested by a user to do so (e.g., when the poll results are made available or at other times). For instance, polling system 101 may inform polling analytics system 102 that new poll results are available. Responsive thereto, polling analytics system 102 may begin analyzing the poll results (as described herein) or otherwise add the new polling results to a queue for such analysis to take place in batches (e.g., hourly, nightly, etc.).

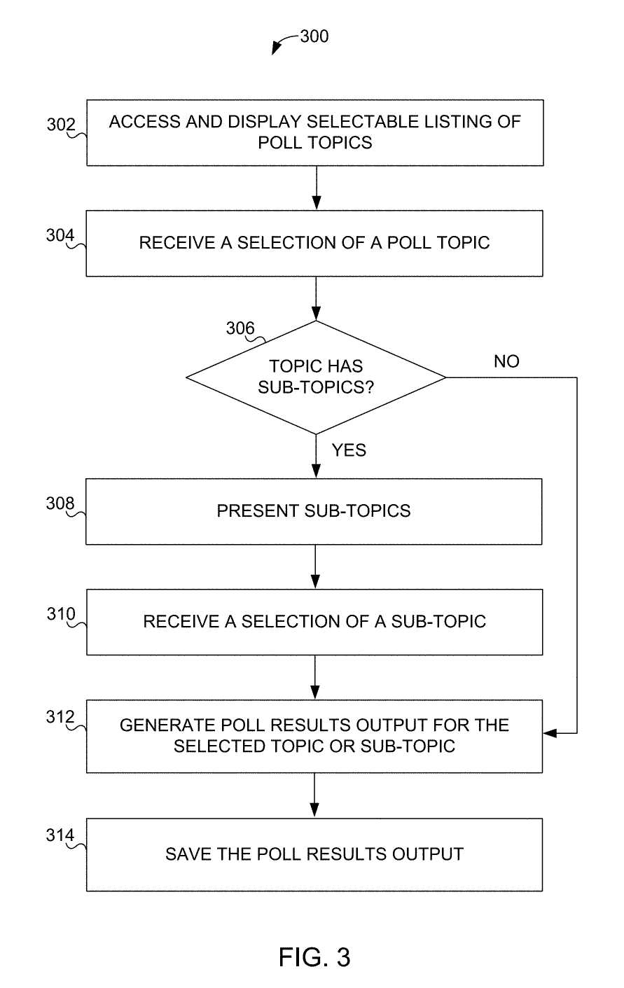

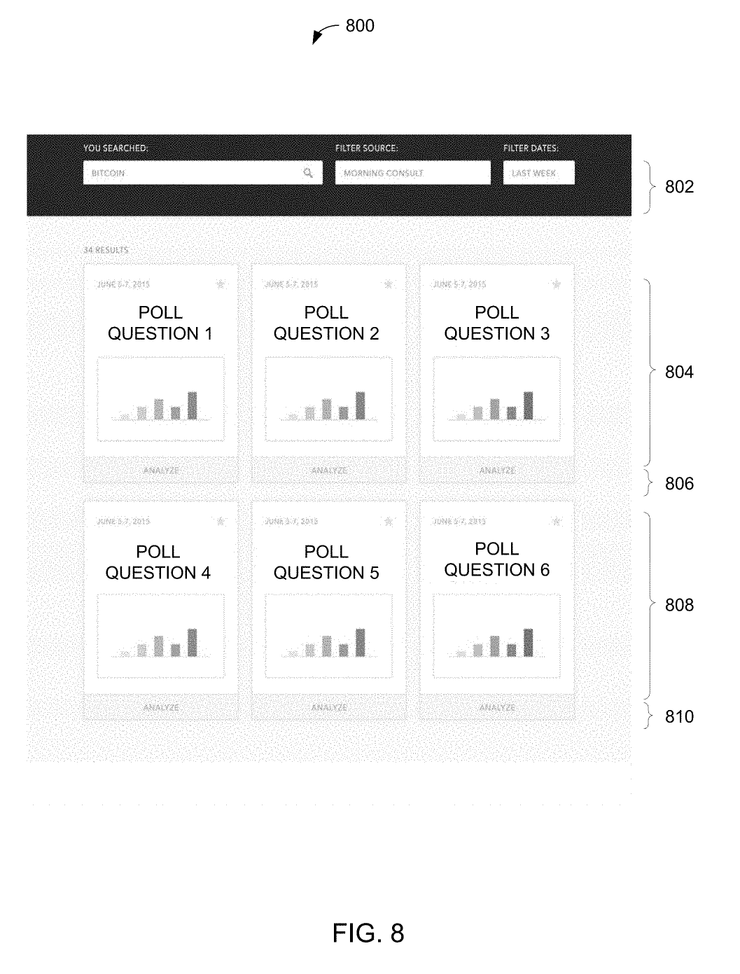

FIG. 3 illustrates a flow diagram of a process 300 for analyzing poll results and generating poll results outputs, according to an implementation of the invention. For instance, a given display mode is illustrated in each of FIGS. 8-12. Process 300 may be performed by poll results analyzer 220 and/or other component of system 100.

In an operation 302, process 300 may include accessing and displaying a selectable listing of poll topics. For instance, poll topics available from polling system 101 may be accessed and displayed for selection by a user. In some implementations, the selectable listing of poll topics may result from a search of topics. For instance, referring to FIG. 8, section 802 allows one or more search parameters, such as search terms/keywords, date/time parameters (e.g., of when poll results were obtained, when poll results were analyzed, a date/time to which the poll relates—such as poll questions relating to the President's performance during a given time period, etc.), and/or other search parameters.

Process 300 may include executing the search based on the search parameters. The search may be executed on poll results from polling system 101 and/or based on analyzed poll results from polling analytics system 102 (e.g., previously saved poll result outputs). The search may use conventional keyword matching on topics, sub-topics, poll source, poll respondent demographics, and/or other information related to the poll results. Results of the search may be presented in sections 804, 808. Of course, sections 804, 808 may include listings of poll topics unrelated to a search as well (e.g., a listing of all available poll topics).

In an operation 304, process 300 may include receiving a selection of a poll topic. For instance, referring to FIG. 8, a user may select the “ANALYZE” interface member (e.g., button) presented at sections 806, 810 for a corresponding topic.

In an operation 306, process 300 may include determining whether the poll topic includes sub-topics. If the selected poll topic includes sub-topics, in an operation 308, process 300 may include presenting the sub-topics for selection by the user.

In an operation 310, process 300 may include receiving a selection of a sub-topic. Such selection may be made in a manner similar to selecting a poll topic. Although not illustrated in FIG. 3, sub-topics may themselves include other selectable sub-topics, may be presented for selection by the user until all sub-topics have been traversed.

In an operation 312, process 300 may include generating a poll results output for the selected topic or sub-topic. The poll results output may be generated based on analysis that has been performed beforehand (e.g., predefined) or on-demand at the time of the request to analyze the selected topic or sub-topic (e.g., when the “ANALYZE” button was selected).

In an operation 314, process 300 may include saving the poll results output. For instance, a poll result output may be saved for later viewing. Alternatively or additionally, the topic or sub-topic may be saved for later viewing, in which case the poll results presentation may be generated based on the saved topic or sub-topic (and/or parameters used to generate the poll results presentation). The saved poll results outputs may be stored in association with a user identifier so that a given user may save one or more poll results outputs and/or poll topics/sub-topics for later viewing or analysis.

Overlaying Secondary Information onto Poll Results

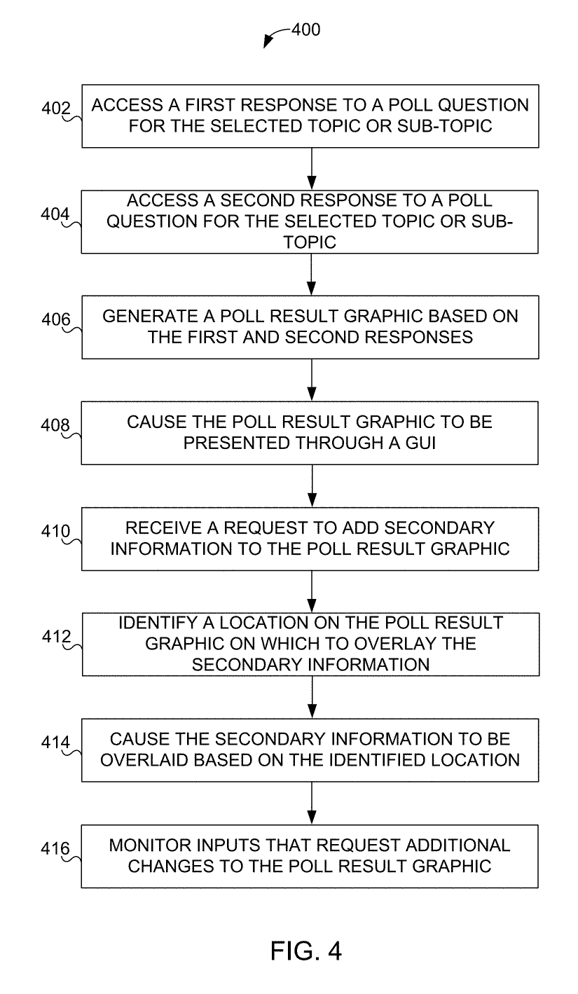

FIG. 4 illustrates a flow diagram of a process 400 for generating a display of secondary information overlaid onto poll results, according to an implementation of the invention. Process 400 may be performed by poll results analyzer 220 and/or other component of system 100. The secondary information may relate to the poll results, but may not be a response to a poll question. For instance, the poll may relate to how the President is handling the economy. The secondary information may include economic indicators, such as stock market activity, consumer sentiment, unemployment figures, gross domestic product, and/or other economic information that relates to the poll (e.g., the economy), but is not a response to a poll question. In this manner, the secondary information overlaid onto the poll result output may provide a more robust view of the poll results.

Furthermore, when the secondary information includes objective indicators (as in the economic indicators example), the objective information may be compared to the (potentially) subjective nature of the poll responses. Of course, the secondary information may include subjective information as well. For instance, the secondary information may include poll responses related to how a previous President handled the economy so that the previous and current Presidents may be compared on the economy (or respondents' view thereof). Other secondary information may be similarly overlaid onto poll results.

In an implementation, the secondary information may include social media or other networked information obtained via a network. For example, the system may obtain social media, news media, and other types of networked data through JAVASCRIPT OBJECT NOTATION (JSON) files. Other types of files and streaming data may be used as well. In a particular example, the system may obtain a streaming feed of posts from Twitter™ and a streaming feed of news articles through an API (such as an API 116) and integrates the data into its database (e.g., database 114). This allows users to visualize and overlay multiple data sets onto public opinion data, such as polling data from polling computer 103 described herein. For example, the system may generate a chart that displays positive polling data for an entity such as a given company over time and then overlay the number of “TWEETS” from Twitter™ that also mention that company on a given day. This allows users to quickly analyze the extent to which conversations or discussions on social media platforms, like Twitter™, reflect or affect public opinion as measured through survey methodologies. In some instances, brand scores for an entity may be overlaid with the number of TWEETS regarding the company.

In an operation 402, process 400 may include accessing a first response to a poll question relating to a particular topic, the first response being stored in a physical memory in association with first respondent information that includes a plurality of first characteristics of a first respondent from which the first response was received.

In an operation 404, process 400 may include accessing a second response to the poll question, the second response being stored in the physical memory in association with second respondent information that includes a plurality of second characteristics of a second respondent from which the second poll questionnaire response was received.

In an operation 406, process 400 may include generating a poll result output based on the first response and the second response.

In an operation 408, process 400 may include causing the poll result output to be presented via a graphical user interface.

In an operation 410, process 400 may include receiving a request to add secondary information to the poll result output.

In an operation 412, process 400 may include identifying a location on the poll result output on which to overlay the secondary information based on information presented on the poll result output. Such location may depend on various factors such as, without limitation, the size of the poll result output, the time scale, and/or other factors. For instance, a given poll (or plurality of polls) may ask respondents how the President handled unemployment at different months and economic indicators for those months may be aligned accordingly in the poll result output. Such poll result output (and non-polling data) may be limited to a particular time period. For example, the poll results may correspond to poll responses from users within the particular time period, and the non-polling data may have been created (e.g., posted to social media platforms or provided from news feeds) during the particular time period. As such, the poll results and non-polling data may relate to the same time period. For brand score implementations, this allows brand scores to be tracked over different time periods so that brand score trends may be analyzed.

In an operation 414, process 400 may include, responsive to the request to add the secondary information, causing the secondary information to be overlaid onto the poll result output based on the identified location. Causing the secondary information to be overlaid onto the poll result output may include generating a new poll result output with the secondary information, updating the poll result output to include the secondary information, or overlaying a new presentation corresponding to the secondary information onto the poll result output. Whichever manner is used to overlay the secondary information onto the poll result output, process 400 may include generating the poll result output and providing the poll result output to the end user device 140 (or whichever device will be viewing or obtaining the poll result output) and/or may provide instructions to the end user device 140 (or other device) that causes the receiving device to render the poll result output.

In an operation 416, process 400 may include determining whether further requests to change the modified poll result output is received. For instance, process 400 may monitor inputs at a GUI 112 through which a poll presentation is presented to determine whether additional or different parameters have been requested to change the mode (e.g., from a map mode to a chart mode) of the poll result output or add additional filter parameters (e.g., view demographics). In an implementation, process 400 may include causing instructions to be provided to the end user device that causes one or more further requests to change the poll result output to be received and processed to further update the poll result output upon receipt of the one or more further requests. For instance, such updates may be made in real-time upon receipt of the one or more further requests such that the further requests are not stored and later acted upon, but rather acted upon receipt of the further requests.

As additional or different parameters are applied, process 400 may dynamically change, update, or otherwise generate a new poll result output based on the additional or different parameters. In some instances, the inputs may be received at end user device 140 (or other device) and passed to polling analytics computer system 110, in which case the polling analytics computer system 110 processes the request and overlays secondary information onto the poll result output as described herein. In other instances, the inputs may be received at end user device 140 (or other device), which uses instructions (e.g., JAVASCRIPT or other client-executed scripts/code) provided from polling analytics computer system 110 to re-render the display accordingly.

Generating Dynamically Changing Views of Poll Results

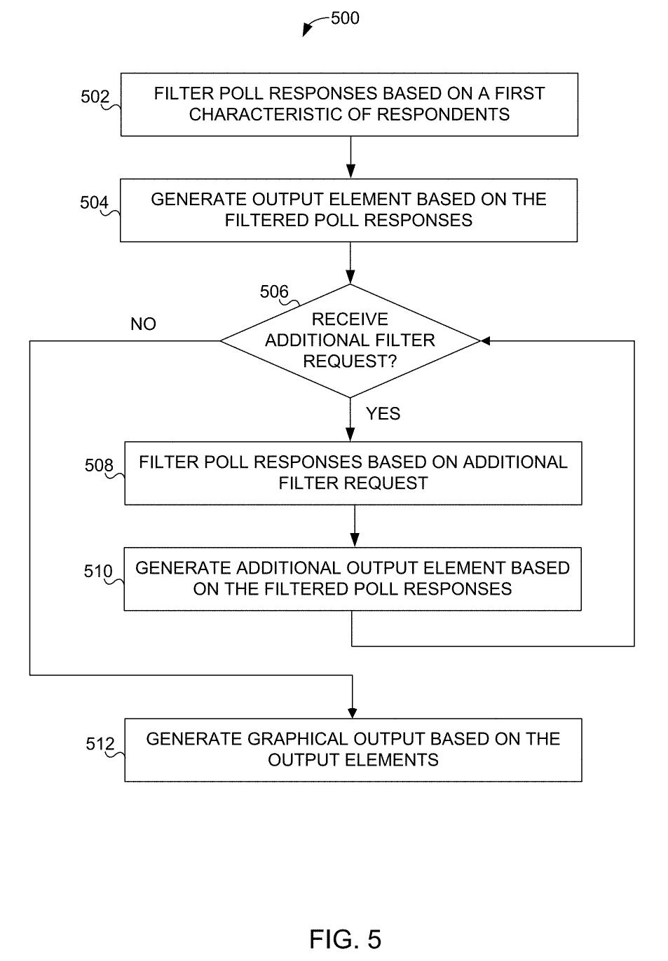

Once generated (whether or not with secondary information overlaid thereon), a display of poll results may be dynamically updated based on one or more filter parameters. FIG. 5 illustrates a flow diagram of a process 500 for dynamically updating a display of poll results based on filter parameters, according to an implementation of the invention. Process 500 may be performed by poll results analyzer 220 and/or other component of system 100.

In an operation 502, process 500 may include filtering poll responses based on a first characteristic of respondents. For instance, poll responses from a first demographic of respondents may be filtered (from the set of all poll responses) and presented as a first output element (e.g., a first bar on a bar graph). Poll responses from a second demographic of respondents may be filtered and presented as a second output element (e.g., a second bar on the bar graph). Other characteristics of respondents may be similarly filtered and presented. Alternatively or additionally, poll responses from respondents having a given characteristic may be omitted from being displayed. Furthermore, two or more characteristics of respondents may be combined in different ways. For instance, poll responses from males (first characteristic) between the ages of 18-32 (second characteristic) may be filtered in to create a output element or may be filtered out to be omitted from being displayed. Other characteristics of respondents may be similarly combined as well.

In an operation 504, process 500 may include generating an output element based on the filtered poll responses. In an operation 506, process 500 may include determining whether additional filter requests have been made. For instance, a user may formulate particular sets of filters to analyze poll results based on certain characteristics of respondents and add (or not) additional filters to apply.

If a further filter request is received, process 500 may include filtering poll responses based on the additional filter request in an operation 508 and updating the polling results output accordingly in an operation 510. Such updates may include adding an additional output element to, removing an output element from, or modifying an output element on the poll results output.

In an operation 512, process 500 may include generating and causing the poll results output to be provided. For instance, process 500 may include causing the poll results output to be transmitted to a remote device, such as end user device 140. In other instances in which end user device 140 generates the poll results output (e.g., based on instructions from polling analytics computer system 110), end user device 140 may display the poll results output.

Saving Favorites and Sharing Poll Results

In an implementation, starring and sharing engine 222 may cause a given poll result output to be stored in association with a user who wishes to save the output. For instance, a user may wish to save a graph relating to a particular poll question. In response, starring and sharing engine 222 may store the graph in association with the user. For instance, starring and sharing engine 222 may store a database association (e.g., a link) between the graph and user identifying information. In this manner, the graph and other saved poll result outputs may be saved in association with the user so that the user may later recall the saved graph (and other saved poll result outputs). Alternatively or additionally, information used to generate the poll result output may be stored in association with the user. For instance, the poll result topic and any filters/parameters used to generate the graph may be stored in association with the user so that the graph may be later generated when recalled.

In an implementation, starring and sharing engine 222 may share a given poll result output via a network. For instance, a poll result output may be shared to a social media platform 120, a content site 130, another user (e.g., through electronic mail, Multi-media Messaging Service message, etc.), and/or other communication channel. For instance, a given poll result output may be displayed in association with a “share” or similar interface member that, upon selection, allows a user to share the output through social media or other communication channel.

Generating Slide Documents and Other Documents with Poll Results

In an implementation, slide document generation engine 224 may generate a slide document (e.g., a PowerPoint® presentation graphics program document) that includes one or more poll result outputs. The slide document can be configured with various slides (or pages), each slide having one or more of the poll result outputs. In this manner, using system 100, a user may automatically generate slide presentations with embedded poll results outputs. As described herein, the term “slide document” will be used for convenience and illustration, but not limitation. Other types of documents, such as word processing documents, spreadsheet documents, PDF document, etc., may be generated by slide document generation engine 224 as well.

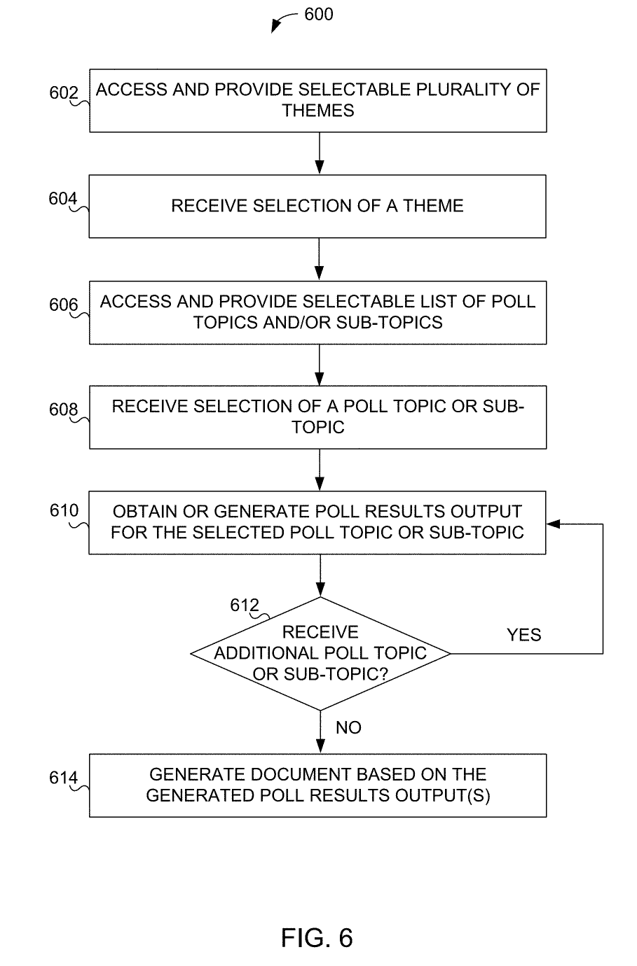

FIG. 6 illustrates a flow diagram of a process 600 for dynamically generating a slide document based on selectable polls, according to an implementation of the invention. Process 600 may be performed by slide document generation engine 224 and/or other component of system 100.

In an operation 602, process 600 may include accessing a plurality of themes and providing a selectable listing of the themes. The themes may be pre-stored in a themes database, such as a database 114. A given theme may include various appearance parameters that controls the appearance (e.g., colors, fonts, graphics, layout, orientation, etc.) of slide documents that use the given theme. Themes may be generic in that they are not customized for any given user or entity, or themes may be custom in that they have been generated or customized by a user or entity. For instance, custom themes may include corporate logos/graphics, and/or other customized appearance parameters.

In an operation 604, process 600 may include receiving a selection of a theme. For instance, a user may select a given theme they wish to use to generate a slide document.

In an operation 606, process 600 may include accessing a plurality of poll topics and/or sub-topics and providing a selectable listing of the poll topics/sub-topics. Such topics and sub-topics may be accessed based on all available topics/sub-topics or may be access based on a search query used to search for particular topics/sub-topics of interest.

In an operation 608, process 600 may include receiving a selection of a poll topic/sub-topic. For instance, a user may select a given poll topic so that results of the selected poll topic are included in the slide document. For instance, the user may select an “add to slide” button to indicate that a poll result output related to the selected poll topic should be added to a slide of the slide document. In some instances, a user may specify on which slide a given poll result output should be placed, as well as, or alternatively, a location on the slide. In some instances, process 600 may maintain a counter that counts the number of poll result outputs to be added to the slide document so that they may each be added in the order in which their corresponding poll topics are selected by the user. Alternatively or additionally, process 600 may generate a queue of poll result outputs so that they may be added in an order based on the queue. In some instances, one slide may be generated for each poll result output to be added.

In an operation 610, process 600 may include obtaining or generating one or more poll results outcome related to the selected poll topic/sub-topic. In instances where the poll results outcome for the poll topic/sub-topic has been previously generated and stored (e.g., in a database 114), then process 600 may simply obtain access the poll results outcome. In instances where the poll results outcome is not previously stored or where custom filters are desired, process 600 may generate the one or more poll results outcome.

In an operation 612, process 600 may include determining whether additional poll topics or sub-topics have been selected. If additional topics or sub-topics have been selected, processing may return to operation 610 so that additional poll results outputs related to the additional topics/sub-topics may be added to the slide document.

In an operation 614, process 600 may include generating the slide document based on the poll result outputs related to the selected poll result topic(s)/sub-topic(s). As previously noted, the slide document may be generated based on location information specified by the user (e.g., slide number, location on a slide, etc.), based on an automatically generated counter or queue, and/or other technique.

Analyzing Polling Trends

In an implementation, trend analytics engine 226 may perform trend analysis on poll related information available to polling analytics system 102. For instance, trend analytics engine 226 may determine trends that indicate a popularity of a given poll topic, a set of poll topics, a subject matter of poll topics (e.g., politics-related, economy-related, technology-related, etc.) based on a number of times that each have been accessed, saved or shared (e.g., through starring and sharing engine 222), etc. In this manner, trend analytics engine 226 may determine what types of poll results are popular among users or entities that generate poll result outputs using the system.

In some instances, trend analytics engine 226 may determine trends related to poll results themselves. For instance, trend analytics engine 226 may determine, from the poll results available through polling system 101, that sentiment relating to a topic is increasing, decreasing, or remaining the same (statistically speaking) for a given time period. For instance, trend analytics engine 226 may detect an upward (or downward) trend in consumer confidence over the last six months by analyzing polling results related to consumer confidence within the last six months.

Whichever type of trends are determined, trend analytics engine 226 may cause a poll result output to be generated that illustrates the trend. For instance, a poll result output may be generated that includes a graph of the trend over time. In some of these instances, the trend may be compared to a trend or other poll results from a prior point in time. For instance, the trend may be compared to consumer sentiment from the same period of time from a prior year, and both sets of trends or data may be overlaid onto a single poll result output for comparison.

In an implementation, trend analytics engine 226 may determine trends based on respondent demographics (e.g., gender, residence location, etc.), geography pertaining to a poll (e.g., poll questions related to different geographic locations), and/or other characteristic of the poll data.

BRAND SCORING

Aggregating Content for Entity Scoring

In an implementation, content aggregator engine 228 may aggregate content from one or more sources such as, for example, polling computer 103/polling database 105, one or more social media platforms 120, one or more content sites 130, and/or other sources.

To aggregate data from social media platforms 120, in some implementations, content aggregator engine 228 may aggregate interface with a API published by a corresponding social media platform. For example, content aggregator engine 228 may establish one or more types of communications with a social media platforms 120, and format data (e.g., requests for content) to the social media provider using a communication protocol, which may be specified by the API.

To aggregate data from content sites 130, content aggregator engine 228 may subscribe to a news feeds (e.g., a Rich Site Summary feed), subscribe to and parse newsletters (which may be industry-specific newsletters for specific industries), read physical print media (which may be scanned by, for example, employees or others working on behalf of an operator of the system) using optical character recognition or other computer vision techniques, and/or otherwise obtain regular media (non-social media data which is generally although not necessarily user-generated for consumption by other users) data.

Scoring Entities Based on Aggregated Poll, Social, and/or Regular Media Data

In an implementation, entity scoring engine 230 may generate a score that relates to an entity based on the aggregated data. For example, entity scoring engine 230 may generate the score based on the polling data, the social media data, the regular media data, combinations of the foregoing, and/or other data aggregated by content aggregator engine 228. Regardless of the type(s) of aggregated data that is analyzed, entity scoring engine 230 may classify the data into different categories of results. These categories and their associated values may be used to generate an entity score. Table 1 below provides a non-limiting example of such categories.

TABLE 1
Table 1 includes non-limiting examples of a category of results and descriptions
of their corresponding data values for each type of aggregated data.
Other categories of results and other types of
aggregated data may be used as well. Entity scoring engine 230 may use the
categories of results and their respective data values to generate an entity score,
as will be discussed following
a description of the examples illustrated in Table 1.

| | | Social Media Data | Regular Media Data |
|---|---|---|---|
| Result Category | Polling Data Value | Value | Value |
| Very Favorable | Number of respondents | Number and/or content | Number and/or content |
| | who answered with | of Social Media Posts | of Regular Media Posts |
| | “Very Favorable” view | indicate highest | indicate highest |
| | of entity in a poll | favorability views | favorability views |
| | questionnaire | | |
| Somewhat | Number of respondents | Number and/or content | Number and/or content |
| Favorable | who answered with | of Social Media Posts | of Regular Media Posts |
| | “Somewhat Favorable” | indicate second highest | indicate second highest |
| | view of entity in a poll | favorability views | favorability views |
| | questionnaire | | |
| Somewhat | Number of respondents | Number and/or content | Number and/or content |
| Unfavorable | who answered with | of Social Media Posts | of Regular Media Posts |
| | “Somewhat | indicate second highest | indicate second highest |
| | Unfavorable” view of | un-favorability views | un-favorability views |
| | entity in a poll | | |
| | questionnaire | | |
| Very | Number of respondents | Number and/or content | Number and/or content |
| Unfavorable | who answered with | of Social Media Posts | of Regular Media Posts |
| | “Very Unfavorable” | indicate highest un- | indicate highest un- |
| | view of entity in a poll | favorability views | favorability views |
| | questionnaire | | |
| Never Heard Of | Number of respondents | Number and/or content | Number and/or content |
| | who answered with | of Social Media Posts | of Regular Media Posts |
| | “Never Heard Of” view | no awareness of entity | no awareness of entity |
| | of entity in a poll | | |
| | questionnaire | | |
| Heard Of, but No | Number of respondents | Number and/or content | Number and/or content |
| Opinion | who answered with | of Social Media Posts | of Regular Media Posts |
| | “Heard Of, but No | awareness of, but no | awareness of, but no |
| | Opinion” view of entity | opinion of entity | opinion of entity |
| | in a poll questionnaire | | |

Analyzing Polling Data for Brand Scoring

Referring to Table 1, for polling data, each category of results may correspond to direct responses to polling questions. For example, a question may be posed to respondents “Do you have a favorable or unfavorable impression of <Entity>?” in which “<Entity>” corresponds to an entity for which a brand score is being generated. The responses may include the categories illustrated in Table 1, such as: “Very Favorable,” “Somewhat Favorable,” “Somewhat Unfavorable,” “Very Unfavorable,” “Never Heard Of,” “Heard Of, but No Opinion.” Other types of poll responses may correspond to other categories as well. Each category of results may correspond to a number of respondents who provided an answer corresponding to that category. The polling data may be obtained from polling system 101, as described herein elsewhere.

Analyzing Non-Polling Data (e.g., Social and Regular Media Data) for Brand Scoring

For non-polling data, which may not be directly categorized (e.g., social media and regular media data), entity scoring engine 230 may further analyze the content to place the content into one of the above categories of results. For example, and without limitation, entity scoring engine 230 may perform the following analysis on social media content items (e.g., social media posts), regular media content items (e.g., news articles), and/or other types of content that is not directly able to be categorized (unlike, for example, poll results data).

In an implementation, entity scoring engine 230 may parse the content (e.g., words or phrases, graphics such as “emoji”, comments such as comments to a news article, etc.) of the non-polling data to categorize the non-polling data. Entity scoring engine 230 may obtain, from a content scoring database (e.g., a database 114), content correlations to one or more values for determining an overall category of the non-polling data. For words or phrases, for example, entity scoring engine 230 may obtain, from the content scoring database, a predefined dictionary that maps words or phrases to positive, negative, or neutral values. In some instances, the positive, negative, or neutral values may correspond to a quantitative score (e.g., 10 for the highest positive and −10 for the lowest negative). The predefined dictionary may be specified by an administrator (e.g., a user who maintains the system), and may be updated to add, remove, or replace the content of the dictionary.

In a particular example, various words or phrases (e.g., “great,” “awesome,” “dependable,” “high quality,” “integrity”) may correspond to relatively high positive values in the dictionary (and in some cases numeric scores such as 10). Other words or phrases (e.g., “good,” “OK,” “above average”) may correspond to less positive (but still positive) values in the dictionary (and in some cases numeric scores such as 7). Still other words or phrases (e.g.,“terrible,” “low quality,” “untrustworthy”) may correspond to negative values in the dictionary (and in some cases numeric scores such as −10″). Still other words or phrases (e.g., “OK,” “average,” “so so”) may correspond to neutral opinions (and in some cases numeric scores such as 0″).

It should be noted that the dictionary of values may not be a full comprehensive set of words or phrases, and that known synonyms (including slang synonyms) may be used as well. Furthermore, in some instances, multiple languages may be accounted for by automatically detecting the original language and using an automatic language service (e.g., online or client-based language translation services) to automatically (e.g., without human intervention) translate the original language into a base language for processing. Alternatively or additionally, entity scoring engine 230 may compare the foreign language (foreign being relative to a base language used by the system) to different dictionaries stored in the content scoring database, each dictionary corresponding to a different foreign language.

Similar to parsing and assigning values to words or phrases, entity scoring engine 230 analyze emojis and similar graphical objects that may be embedded within the content (e.g., social media content or regular media content). For example, depending on the system from which the content was obtained, each emoji may be encoded using a particular identification, which corresponds to a particular graphic (e.g., a thumbs up or down graphic, a smiley face graphic, etc.) to be displayed. The content scoring database may store the emoji identifications in association with positive or negative values (e.g., values similar to those described above with respect to the words or phrases).

Once the content is parsed (or otherwise read) by entity scoring engine 230, the number of content matches to the dictionary (and their corresponding values) may be determined. For example, entity scoring engine 230 may determine characterize a given piece of non-polling data as being “very favorable” or other category of results. To do so, in one implementation, entity scoring engine 230 may count the number of different types of word or phrase or emoji matches to the dictionary. For example, for a given social media post, entity scoring engine 230 may count the number of “high positive” matches, “less positive” matches, “average” matches, and “negative” matches. Other types of matches may be counted as well (such as a different numbers of positive or negative matches).

Based on the number of types of matches for a given social media post, entity scoring engine 230 may determine that the post had a “Very Favorable” sentiment or other types of sentiment. For example, entity scoring engine 230 may determine that the post had a very favorable sentiment if a certain percentage of matches (e.g., 70 and above) were high positive matches, a somewhat favorable sentiment if a certain percentage of matches (e.g., 20 to 70) were high positive matches or if a certain percentage of a total of less positive matches and high positive matches exceeds a certain percentage such as 70). Likewise, negative sentiments may be determined based on certain percentages of matches to negative matches. Neutral sentiments may be determined when neither positive or negative matches exceeds a requisite threshold or when average matches exceeds a certain percentage threshold. These thresholds may be initially system by an administrator or other users, and may be updated from time to time.

Once each of the non-polling data items have been characterized, entity scoring engine 230 may count the number of each type of characterization and place the count in a corresponding category of results. For example, the number of content items having a “Very Favorable” sentiment, “Somewhat Favorable” sentiment, “Somewhat Unfavorable” sentiment, “Very Unfavorable” sentiment, and “Heard Of, but No Opinion” (e.g., average) sentiment may be counted.

Generating an Entity Score based on the Analysis of the Aggregated Data

In an implementation, once the different types of data have been analyzed and characterized as described above, entity scoring engine 230 may generate a brand score for an entity based on the analysis. To generate the brand score, entity scoring engine 230 may generate a sub-score for each type of data (and an overall brand score based on one or more of the sub-scores). For example, entity scoring engine 230 may generate a sub-score for the polling data, and a sub-score for each of the different types of non-polling data. The sub-score may be expressed as a letter grade (e.g., A+, A, A−, B+, B, B−, C+, C, C−, D+, D, D−, F, etc.). Other types of scoring representations may be used as well.

Generally speaking, entity scoring engine 230 may generate a sub-score based on the numbers of different categories of results for a given type of aggregated data. For example, and without limitation, entity scoring engine 230 may determine a number of polling responses of each of “Very Favorable,” “Somewhat Favorable,” “Somewhat Unfavorable,” “Very Unfavorable,” “Never Heard Of,” “Heard Of, but No Opinion” for polling data. Likewise, entity scoring engine 230 may determine a number of social media posts that were categorized into each of “Very Favorable,” “Somewhat Favorable,” “Somewhat Unfavorable,” “Very Unfavorable,” “Never Heard Of,” “Heard Of, but No Opinion” for social media data. Still likewise, entity scoring engine 230 may determine a number of media articles that were categorized into each of “Very Favorable,” “Somewhat Favorable,” “Somewhat Unfavorable,” “Very Unfavorable,” “Never Heard Of,” “Heard Of, but No Opinion” for regular media data.

For each of the types of aggregated data, entity scoring engine 230 may compare the above results to a group of entities similar to the entity to be scored. “Similar entities” may include competitors (e.g., competing companies, competing products, opposing politicians in an election, individuals in the same profession such as professional athletes, entertainment celebrities, etc.), entities sharing some other characteristic (e.g., companies in a Fortune® 100 list, companies on a stock index such as the S&P 500®, etc.). In this sense, each sub-score may be a relative score in that entities having the most number of “Favorable” results will have higher scores relative to entities having a lower number of “Favorable” results.

In a particular implementation, entity scoring engine 230 may determine the overall number of “Favorable” results (e.g., sum of “Very Favorable” and “Somewhat Favorable” results) and the overall number of “Unfavorable” results (e.g., sum of “Somewhat Unfavorable” and “Very Unfavorable” results). “Never Heard of” and “Heard of, but no Opinion” results may be counted as an “Unfavorable” result, may be ignored, or may be used to generate an entirely different sub-score such as a recognition subscore. Once the different results have been counted, entity scoring engine 230 may generate a ratio of “Favorable” results to “Unfavorable” results and compare this ratio to the ratios of similar entities. For example, an entity having 50 Favorable results and 10 Unfavorable results will be assigned a ratio of 5. This ratio may be compared to the ratio of similar entities. The ratios may be plotted along a distribution graph such that different portions on the graph are assigned with a sub-score.

An entity may be assigned with a sub-score based on the entity's ratio position on the distribution graph. For example and without limitation, entities within the top 15% on the graph (e.g., the highest 15% of the ratios) will be given a score in the “A” range (with the top third getting an A+, middle third getting an A, and lower third of this range getting an A−). Likewise, the next 30% on the graph will be given a score in the “B” range (with the top third getting a B+, middle third getting a B, and lower third of this range getting a B−), the next 30% on the graph will be given a score in the “C” range (with the top third getting a C+, middle third getting a C, and lower third of this range getting a C−), the next 15% on the graph will be given a score in the “D” range (with the top third getting a D+, middle third getting a D, and lower third of this range getting a D−), and the bottom 10% on the graph will be given a score of “F.”

In some implementations, entity scoring engine 230 may determine a sub-score through other metrics as well. For example, entity scoring engine 230 may determine the sub-score based solely on the number of Favorable results. This number may be normalized by obtaining a percentage by dividing the number of Favorable results by the number of Unfavorable results. The percentage may be plotted on a distribution graph based on percentages of similar entities, and a sub-score may be assigned as discussed above with respect to the ratios.

In some implementations, entity scoring engine 230 may use the higher of the determined sub-scores. For instance, if an entity was assigned a B using the ratio metric, but was assigned an A− for the percentage metric, then entity scoring engine 230 select the A− for the sub-score. Of course, an average or other cumulative score (e.g., median) may be used as well. For averages, each letter grade sub-score may be converted to a quantitative value such as an integer or decimal. In a particular example, each letter grade may be converted to a corresponding quantitative value such that an A+ corresponds to a 100, an A corresponds to a 95, and an A− corresponds to a 90. Other letter grades may be similarly converted to numeric values (e.g., a B+ corresponding to an 89, a B corresponding to an 85, and a B− corresponding to an 80, and so on).

In implementations for which only a single sub-score is used to generate an overall brand score for the entity, the sub-score will be used as the overall brand score. However, in implementations in which multiple sub-scores are used to generate the overall brand score, each sub-score may be converted to a quantitative value and a cumulative value based on each quantitative value may be determined. For example, if an entity achieved an A+ in polling results, a B− in social media results, and a C− in regular media results, entity scoring engine 230 may generate an overall brand score by converting each letter grade into corresponding quantitative values (e.g., 100, 80, and 70), and generating a cumulative score for the brand. The cumulative score may be an unweighted average (e.g., (100+80+70) ÷3=83.33 or a B according to the letter grade scale described below) or a weighted average. Other types of cumulative scores may be used as well (e.g., median value of 80). Once a quantitative cumulative score has been determined, entity scoring engine 230 may convert the quantitative value back into a cumulative letter grade based on a letter grade scale according to the following non-limiting example: less than 60 is an F; 60 to less than 63 is a D−; 63 to less than 66 is a D, and 67 to less than 70 is a D+; 70 to less than 73 is a C−; 73 to less than 76 is a C, and 77 to less than 80 is a C+; 80 to less than 83 is a B−; 83 to less than 86 is a B, and 87 to less than 90 is a B+; and 90 to less than 93 is an A−; 93 to less than 96 is an A, and 97 to 100 is an A+.

For weighted averages, each sub-score may be weighted according to a level of importance in brand scores. For example, polling data may be weighted most heavily with a scaling factor of 0.7, social media data may be weighted with a scaling factor of 0.2, and regular media data may be weighted with a scaling factor of 0.1. The quantitative values of each of the sub-scores may be scaled accordingly before being cumulated. For example, a polling data quantitative sub-score of 100 may be scaled to be 70 (100*0.7); the social media quantitative sub-score of 80 may be scaled to be 16 (80*0.2); the regular media quantitative sub-score 70 may be scaled to be 7 (70*0.1). In the foregoing example, the overall scaled quantitative sub-score will be 70+16+7, or 93, which would correspond to an overall score of “A” according to the above grade scales.

In some implementations, the system may present the sub-scores (quantitative and/or letter), overall brand score (quantitative and/or letter), and/or other information when presenting the scores. In some instances, the system may present one or more selectable options that cause one or more of the types of data to be weighted, or weighted differently, to achieve an overall brand score. In this manner, users may be able to fine-tune their own brand scores according to their needs. Alternatively or additionally, the system may enable each user to predefine the weights so that they are provided with customized brand scores. In either of the foregoing instances, the system may generate a generic score with system-defined defaults that are used to provide brand scores in a consistent manner, irrespective of any user-defined settings. In this manner, the system may maintain consistent scoring metrics (or at least store indications of how a given score was generated—e.g., the types of data used and any weights that were applied).

In some implementations, entity scoring engine 230 may periodically generate a brand score so that any updates in sentiment may be captured. Entity scoring engine 230 may also or instead periodically update an overall sector score (which may be an average or other cumulative score) based on brand scores for entities in a given sector (e.g., home improvement retailers), and/or an overall industry score (which may be an average or other cumulative score) based on brand scores for entities in a given industry (e.g., all retailers).

Generating and Providing Alerts based on Monitored Entities

In an implementation, monitor and alert engine 232 may monitor brand scores (including any sub-scores of the entity), brand scores for competing entities (whether in the aggregate or a group), sector brand scores, and industry brand scores, and generate an alert based on the monitored brand scores. For example, if any of the monitored brand scores or sub-scores have changed, monitor and alert engine 232 may obtain contact information relating to an entity from an alerts database (such as a database 114). For example, a registrant such as a user or organization may have registered to use the system to obtain brand scores relating to its entity (whether the entity is a company, product, individual, etc.). The registrant may have signed up to receive alerts relating to any score changes (which may be specified by the registrant).

For example, the registrant may include a marketing executive of a company and elect to receive alerts when the brand score (or any of the sub-scores) for the company has changed, when any score relating to its competitors have changed, when a sector score has changed or when an industry score has changed. In this manner, the alert may provide the registrant (e.g., the registrant's device such as an end user device 140) even if the registrant's device is not connected to the system (e.g., system 102). For example, when back online or otherwise logged on, the alert may cause the registrant's device to provide a message to the registrant that the alert is available. In some instances, the alert may cause the registrant's device to logon to a website or other interface that accesses the various reports described herein. In a particular example, the alert may be encoded with an IP address, a Uniform Resource Indicator address, and/or other type of public address and instructions that cause the registrant's device, when online, to access the one or more reports. In this manner, a registrant's device may be offline and still be able to timely provide the registrant with alerts regarding any changes to any of the scores.

Examples of GUIs and Poll Result and Brand Scoring Outputs

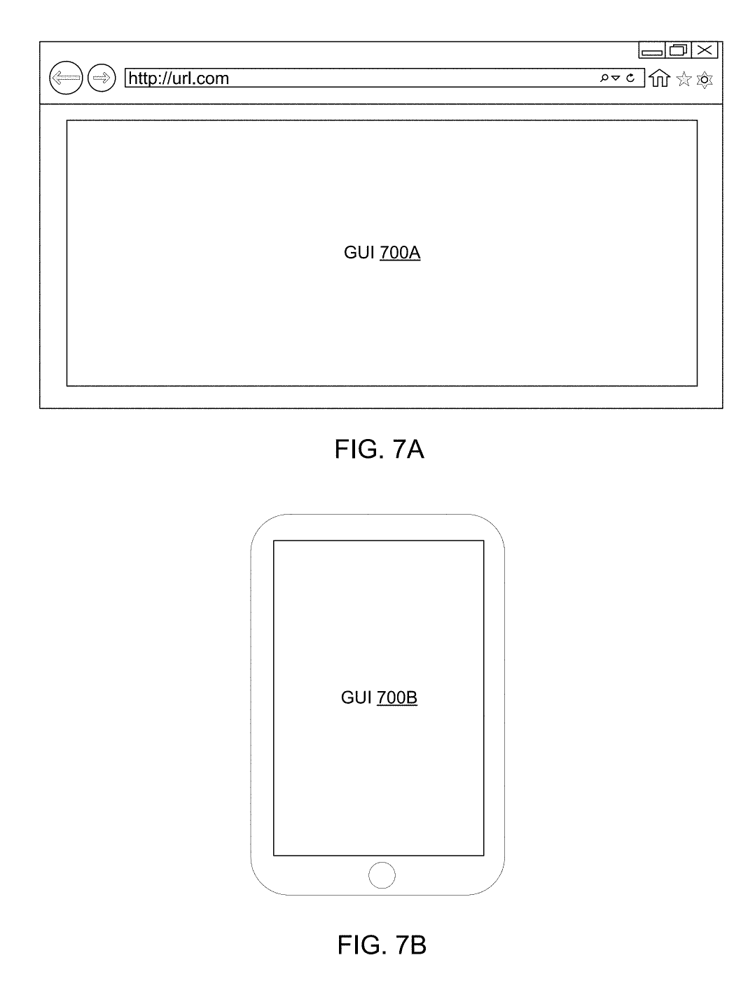

FIG. 7A illustrates a channel through which the poll results output may be presented to a user, according to an implementation of the invention. FIG. 7A illustrates a browser being used to display GUI 700A, which may include an interface through which a poll result output is provided. FIG. 7B illustrates a channel through which the poll results output may be presented to a user, according to an implementation of the invention. FIG. 7B illustrates an end user device (e.g., a mobile deice) that includes an application (e.g., a mobile “app”) that displays GUI 700B, which may include an interface through which a poll result output is provided.

GUI 700A, GUI 700B, and/or other GUI may be used to provide the various user interfaces described herein. Various other types of channels (e.g., electronic mail, MMS, and/or other channel that can convey electronic information) may be used to convey a poll result output as well.

Whichever type of GUI (or channel) is used, polling analytics computer system 110 may generate poll result outputs and provide such outputs for display through the GUI. Furthermore, polling analytics computer system 110 may receive, through the GUI, various inputs to modify a poll result output or to obtain a new poll result output. For instance, a user, through the GUI, may input additional parameters that can be used to update or otherwise replace a given poll result output, as described herein.

Alternatively or additionally, polling analytics computer system 110 may provide, to end user device 140, client-executed instructions (e.g., JAVASCRIPT, FLASH, etc.) to generate a given poll result output. Such instructions may include rules for modifying the poll result output. As would be appreciated, agents (e.g., a web browser that interprets JAVASCRIPT, a FLASH plugin that reads FLASH instructions, etc.) executing at an end user device 140 may receive the instructions from polling analytics computer system 110 and render a poll result output accordingly. Other types of technologies may be used as well, such as proxies that communicate information between polling analytics computer system 110 and end user device 140.

Having provided a non-limiting overview of the ways in which the various poll results outputs may be displayed to a user, attention will now turn to examples of various interfaces that include the outputs.

FIG. 8 illustrates a screenshot of a user interface 800 for providing selectable poll topics, according to an implementation of the invention. Section 802 may be used to input one or more search parameters, such as search terms, date filters, and/or other parameters. Portion 804, 808 may present a selectable listing of poll topics, which may include poll questions. Each poll question may be associated with a poll results output (illustrated as bar graphs, although other types of poll results output may be alternatively or additionally included). Sections 806, 810 may include an “ANALYZE” input member (e.g., button) that, when selected, causes poll results outputs to be provided. For instance, upon selection of the ANALYZE input member, polling analytics computer system 110 may analyze poll results and generate a poll result output and/or may obtain a pre-generated poll result output from a memory.

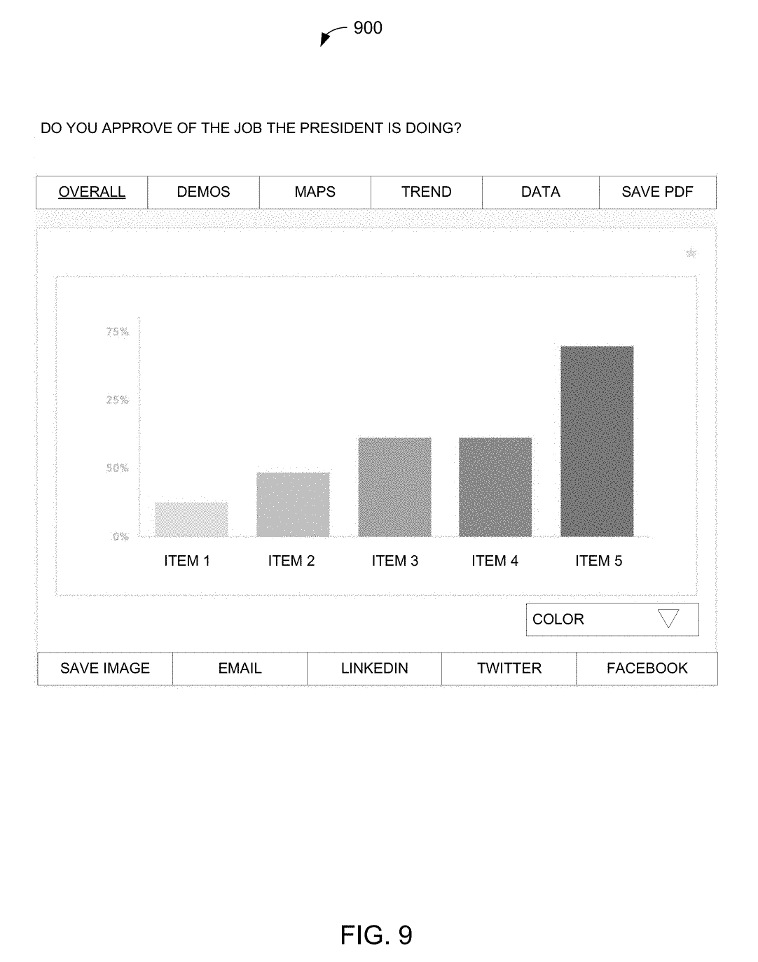

FIG. 9 illustrates a screenshot of a user interface for providing a display mode 900 of a poll results output, according to an implementation of the invention. As illustrated, display mode 900 displays a poll results output configured as a bar graph.

The “OVERALL” member, when selected (as illustrated), may provide poll results for all respondents.

The “DEMOS” member, when selected, may allow a user to select demographics or other filters for modifying the poll result output.

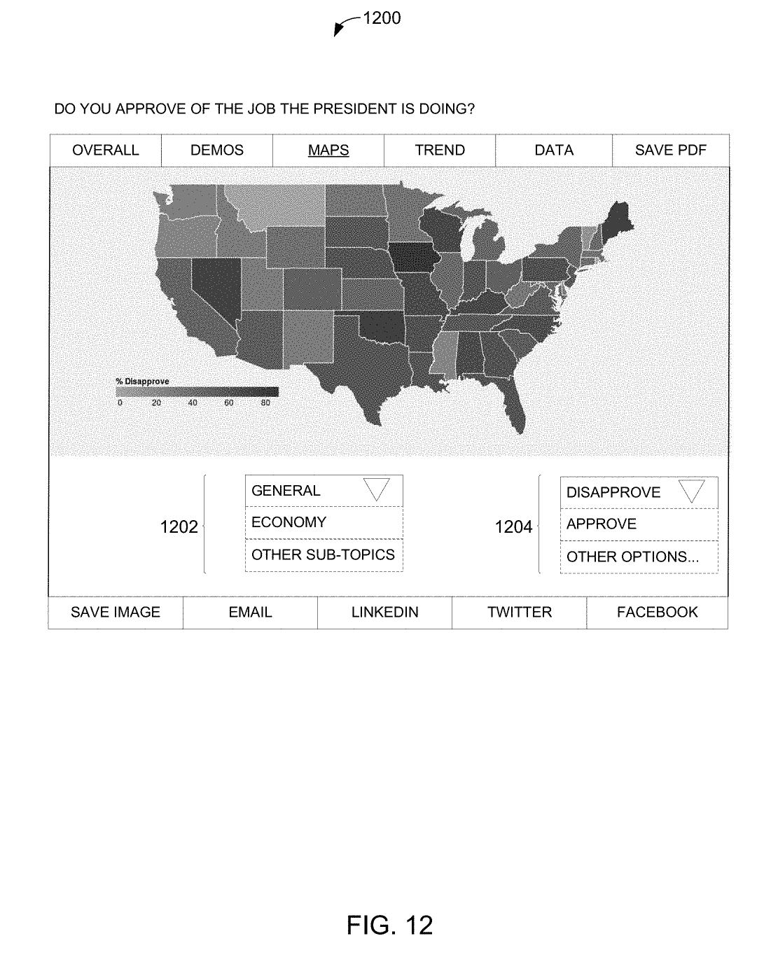

The “MAPS” member, when selected, causes display mode 1200, illustrated in FIG. 12, to be displayed.

The “TRENDS” member, when selected, causes a trend analysis to be conducted on the poll results corresponding to the displayed poll results output.

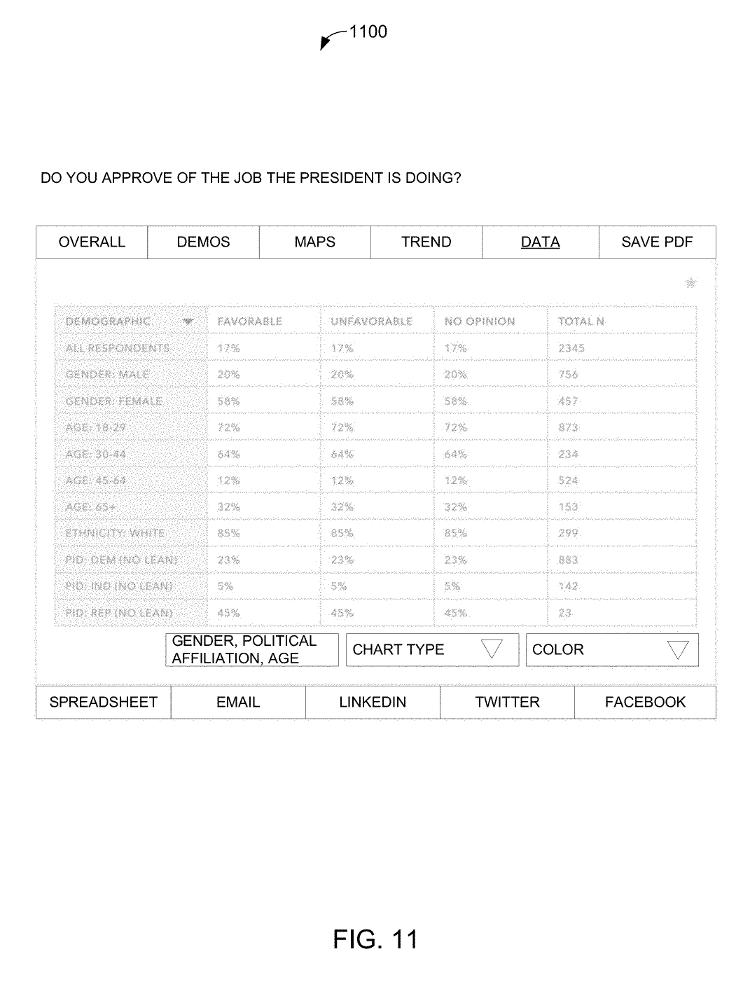

The “DATA” member, when selected, causes display mode 1100, illustrated in FIG. 11, to be displayed.

The “SAVE PDF” member, when selected, causes the poll results output to be saved locally as a PDF file.

The “SAVE IMAGE” member, when selected, causes the poll results output to be saved locally as an image file. The SAVE PDF and SAVE IMAGE related functions are not to be confused with the favorites function described herein, in which a poll results output to be saved in association with a given user.

The “EMAIL” member, when selected, causes the poll results output to be emailed to an email address (which may be later input by the user or may be pre-stored).

The “LINKEDIN” member, “TWITTER” member, or “FACEBOOK” member, when selected, causes the poll results output to be shared via a corresponding social media platform 120.

The “COLOR” member, may allow the user to change the color of the poll results output. Other visual features may be changed as well (e.g., size, orientation, etc.).

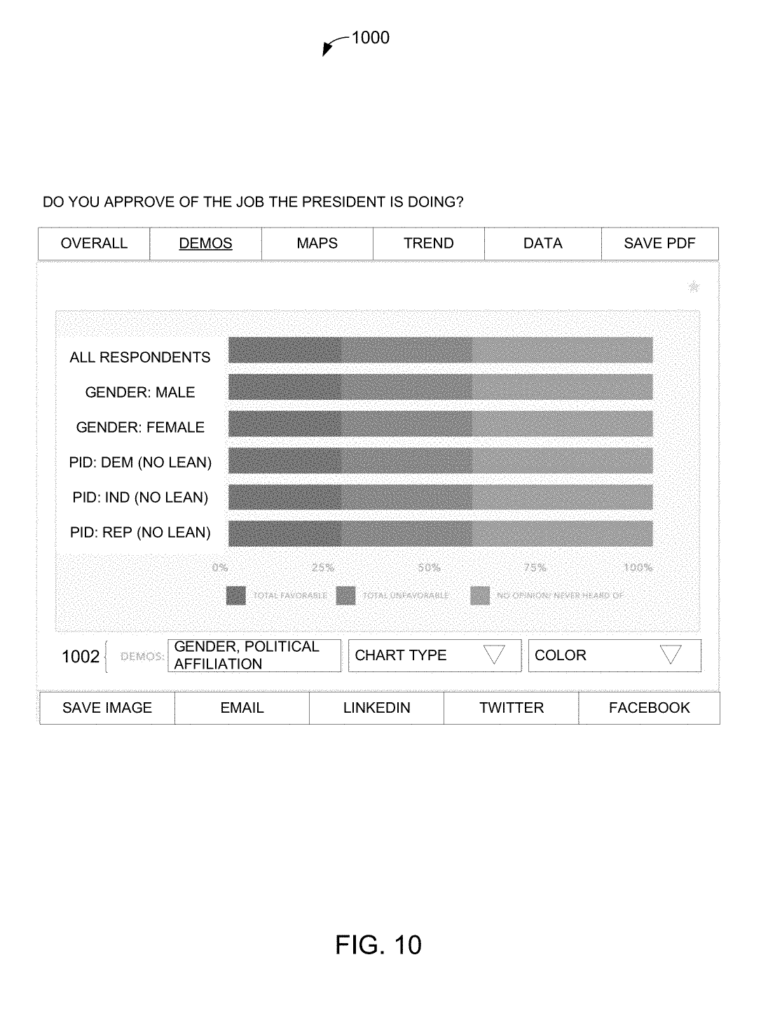

It should be noted that interface members that appear in FIG. 9 (as described above) and in other drawing figures (e.g., FIGS. 10-13) will have similar functionality.

FIG. 10 illustrates a screenshot of a user interface for providing a display mode 1000 of a poll results output based on respondent characteristics, according to an implementation of the invention.

As illustrated, display mode 1000 displays a poll results output configured as a bar graph that shows a breakdown of responses based on respondent characteristics, such as gender and political affiliation. Although not illustrated, the breakdown may include a combination of characteristics such as by gender and political affiliation. Responses based on other respondent characteristics may be similarly displayed, either individually, or in combination with one or more other characteristics.

Portion 1002 may include an input member that allows a user to input filter parameters to add or remove characteristics. As illustrated, “GENDER” and “POLITICAL AFFILIATION” have been input. As additional filter parameters are added, poll results output may be dynamically updated to reflect the additional filter parameters. For instance, a user may input “AGE” to add an additional bar graphic relating to respondents based on their age.

FIG. 11 illustrates a screenshot of a user interface for providing a chart display mode 1100 for providing a poll results output, according to an implementation of the invention. In the illustrated display mode, poll results are provided in a chart, or tabular, format.

As illustrated, “GENDER,” “POLITICAL AFFILIATION,” “AGE,” and “ETHNICITY” have been input as filters to display poll results. As additional filter parameters are added, the chart may be dynamically updated to reflect the additional filter parameters.

FIG. 12 illustrates a screenshot of a user interface for providing a map display mode 1200 for providing a poll results output, according to an implementation of the invention. In the illustrated display mode, poll results are provided in a map format.

As illustrated, map display mode relates to a topic (as illustrated, approval of the President) and one of a plurality of sub-topics (as illustrated, “GENERAL,” “ECONOMY,” and/or other sub-topics). Portion 1202 may be used to select a given sub-topic. Responsive to such as selection, the poll results output may be updated to reflect responses to particular sub-topic. Portion 1204 may be used to view particular responses. For instance, a user may select “DISAPPROVE” to view a map of results of respondents who disapprove of the President's “GENERAL” performance.

A user may select “DISAPPROVE” and “ECONOMY” to view a map of results of respondents who disapprove of the President's performance relating to the economy. Likewise, a user may select “APPROVE” to view a map of results of respondents who approve of the President's “GENERAL” performance. Of course, a sub-topic may be omitted so that the user may simply view results relating to the topic. Likewise, other sub-topics may be added so that the user may view results of additional sub-topics.

Although not illustrated, two or more of the various display modes illustrated in FIGS. 9-12 may be combined into a single display or otherwise be presented simultaneously. For instance, display mode 900 may be displayed along with display mode 1000. Other numbers and combinations of display modes may be displayed together as well.

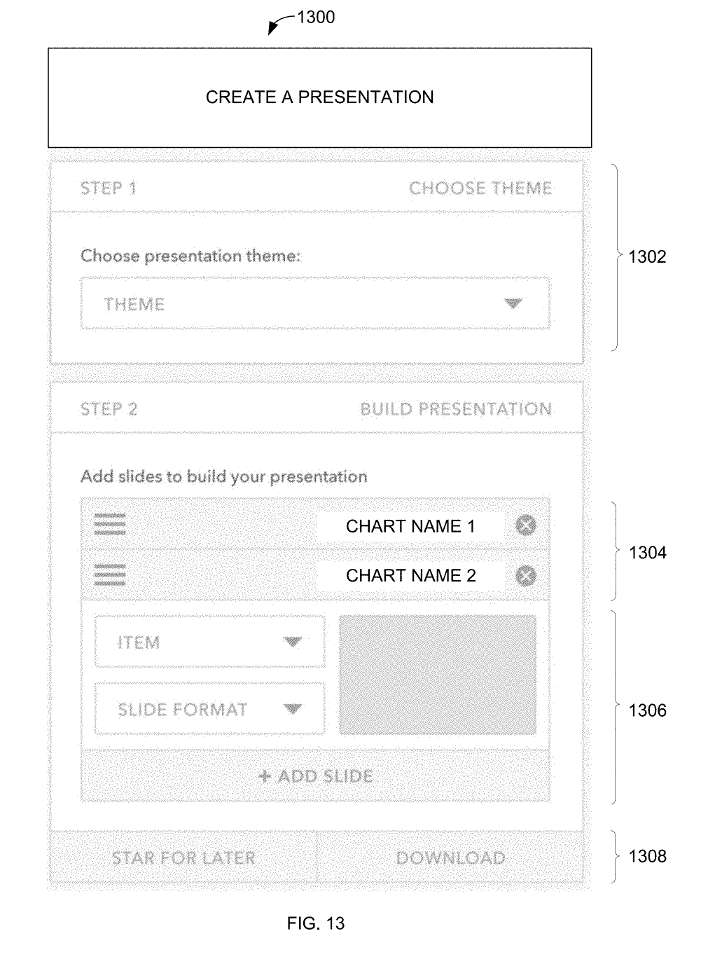

FIG. 13 illustrates a screenshot of a user interface 1300 for generating slide documents that include poll result outputs, according to an implementation of the invention. Inputs received via user interface 1300 may be used by slide generation engine 224 (and/or other components of polling analytics computer system 102).

Portion 1302 may present an interface member to select a theme for the generated slide. (e.g., “CHART NAME 1” for a first chart and “CHART NAME 2” for a second chart; other types of poll results outputs may be named and used as well). Portion 1306 may present an interface member to select an item (e.g., results of a poll topic or sub-topic) to add, an interface member to select a slide format, and an interface member to add a slide to the slide document. Upon selection of an item, a corresponding poll result output will be generated and added to a given slide upon activation of the “ADD SLIDE” interface member. A name of the poll results output (e.g., “CHART NAME 1” for a first chart and “CHART NAME 2” for a second chart; other types of poll results outputs may be named and used as well) may be used based on input values associated with portion 1306.

Portion 1308 may present an interface member “STAR FOR LATER” to star a slide document in association with user identifying information. Portion 1308 may present an interface member “DOWNLOAD” to download a slide document. Other interface members (not illustrated) may be included to share the slide document via email, MMS, social media platforms 120, content sites 130, and/or other channel.

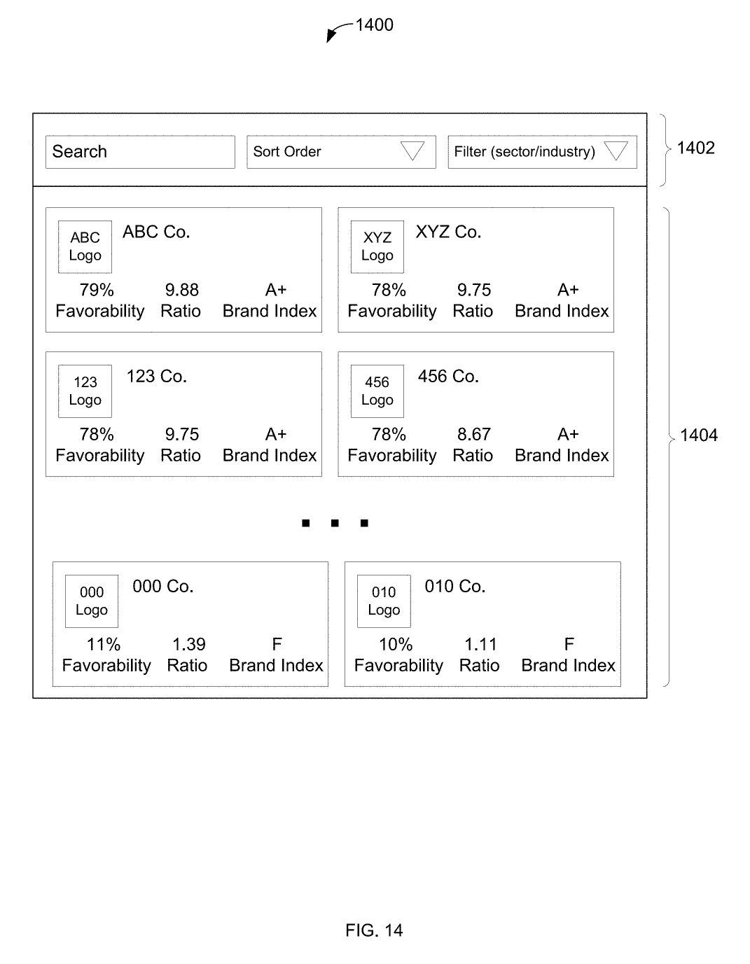

FIG. 14 illustrates a screenshot of a user interface 1400 for displaying company brand scores, according to an implementation of the invention. Inputs received via user interface 1400 may be used by entity scoring engine 230 (and/or other components of polling analytics computer system 102).

Portion 1402 may include navigation display options, such as a search display option, a sort order display option, and a filter display option. The search display option may be configured to receive search inputs to search for companies or other entities for which a brand score may be available. The sort order display option may be configured to receive a sorting preference (which may be defaulted to the sorting based on the brand score). The filter display option may be configured to receive a filtering preference that filters in (or out) based on certain criteria, such as a sector or industry. Other types of sorting and filtering options may be presented and executed as well.

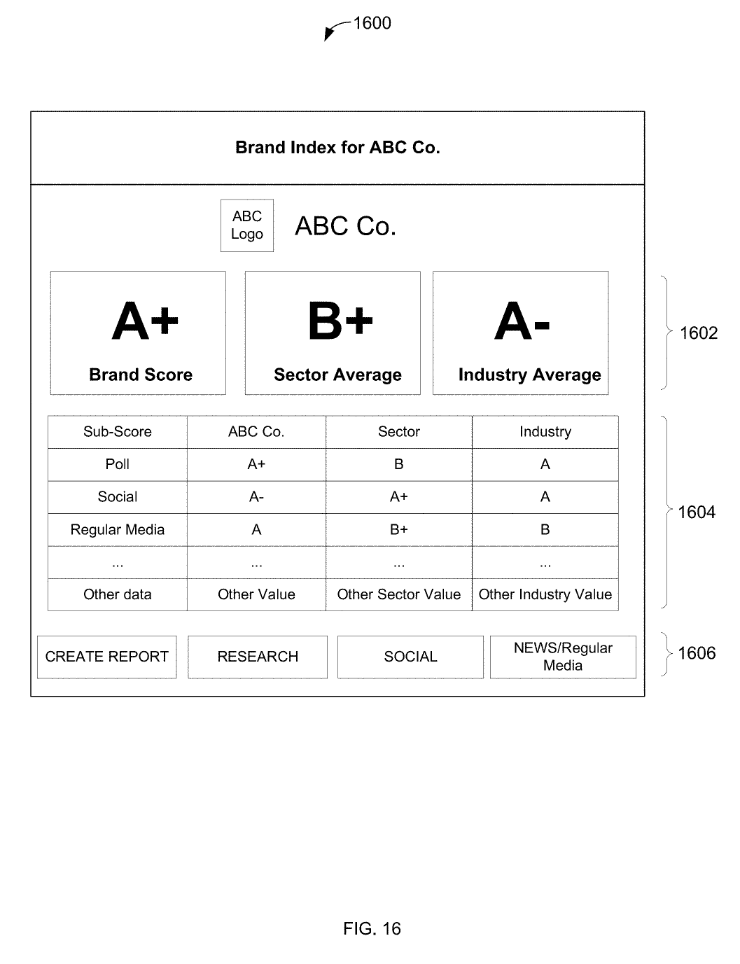

Portion 1404 may include a dashboard of different companies for which a brand score is available. The dashboard may include an individual portion for a given company. Each portion may include a company's logo and company identifier, along with various metrics that may have contributed to the brand score. For instance, a percentage of Favorable results and a ratio of Favorable to Unfavorable results may be displayed. It should be noted that the filtering and sorting options may be used to sort or filter based on the various metrics as well. In an implementation, each portion that displays a company may be selectable. Upon selection, a detailed view of that company may be displayed, as illustrated in FIG. 16.

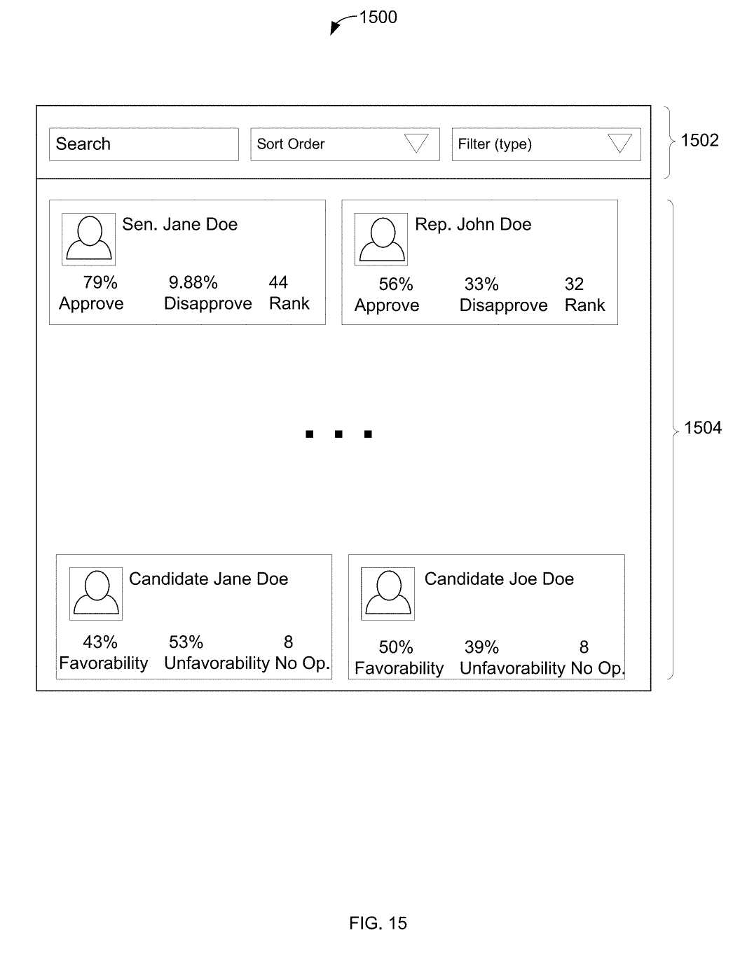

FIG. 15 illustrates a screenshot of a user interface 1500 for displaying politician brand scores, according to an implementation of the invention. Inputs received via user interface 1500 may be used by entity scoring engine 230 (and/or other components of polling analytics computer system 102).

Portion 1502 may function in similarly to portion 1402 illustrated in FIG. 14. That is, the different politicians presented by user interface 1500 may be searched for, sorted, and filtered based on various criteria.

Portion 1504 may include a dashboard of different politicians for which a brand score is available. The dashboard may include an individual portion for a politician. Different metrics may be used to score different types of entities, but the scoring may function in the same way as described above with respect to entity scoring engine 230. For example, for politicians, instead or (or in addition) to “Favorable” or “Unfavorable” categories of results of aggregated data, categories of “Approve” or “Disapprove” may be used. The “rank” in this case may substitute for a brand score. This is to reduce a perception that politicians are being graded. Other entities for which “grading” may be perceived as a negative evaluation may be similarly scored as a rank (or other value) instead of a letter grade as well. However, in some implementations, a letter grade for the brand score for politicians may be used as well.

In some implementations, different metrics may be applied to different types of politicians. For example, the foregoing may apply to sitting politicians holding office, while different metrics may be used for candidates running for office, as illustrated with “Candidate Jane Doe” and “Candidate Joe Doe.”

FIG. 16 illustrates a screenshot of a user interface 1600 for displaying a detailed dashboard for an entity, according to an implementation of the invention. Inputs received via user interface 1600 may be used by entity scoring engine 230 (and/or other components of polling analytics computer system 102).

Portion 1602 may include scores (e.g., brand score, sector average, and industry averages) relating to the entity.

Portion 1604 may include a detailed view of sub-scores that may have contributed to the overall brand scores displayed in portion 1602. Portion 1604 may enable a user to rapidly identify any area of weakness in terms of type of data that should be improved to improve brand image of an entity.

Portion 1606 may include various command options that cause various commands to be executed when selected. For example, a “create report” command option may cause one or more reports (e.g., those described in any of the illustrated user interfaces) that include information described herein to be generated. A “research” command option may cause one or more of the user interfaces described herein to be presented so that a user may investigate details of metrics and scoring described herein. A “social” command option may cause any aggregated social media used in brand scoring to be presented. A “News/regular media” command option may cause any aggregated regular media or news to be presented.

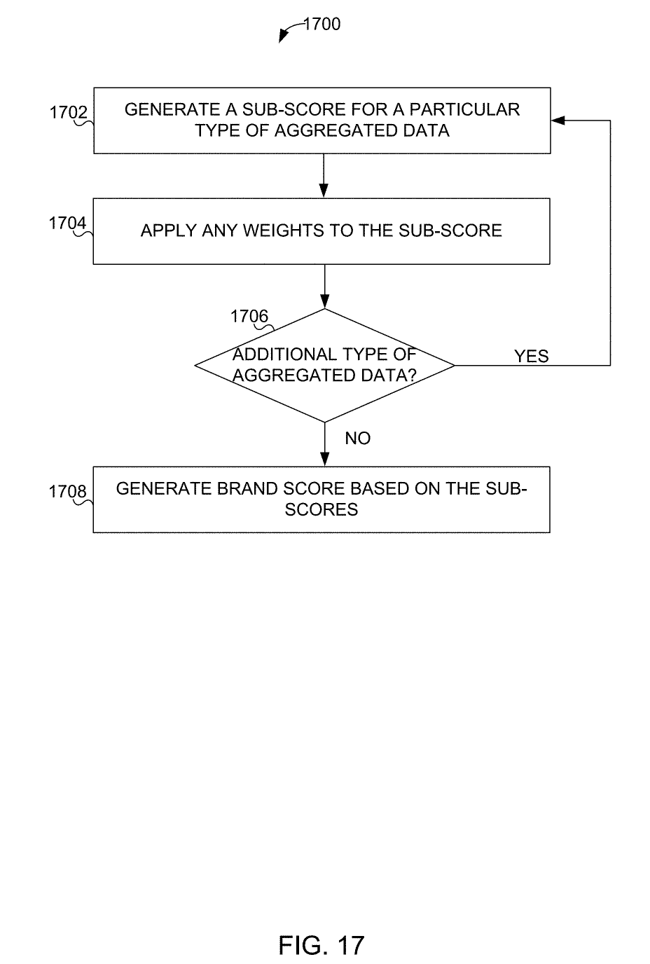

FIG. 17 illustrates a flow diagram of a process 1700 for generating a brand score, according to an implementation of the invention.

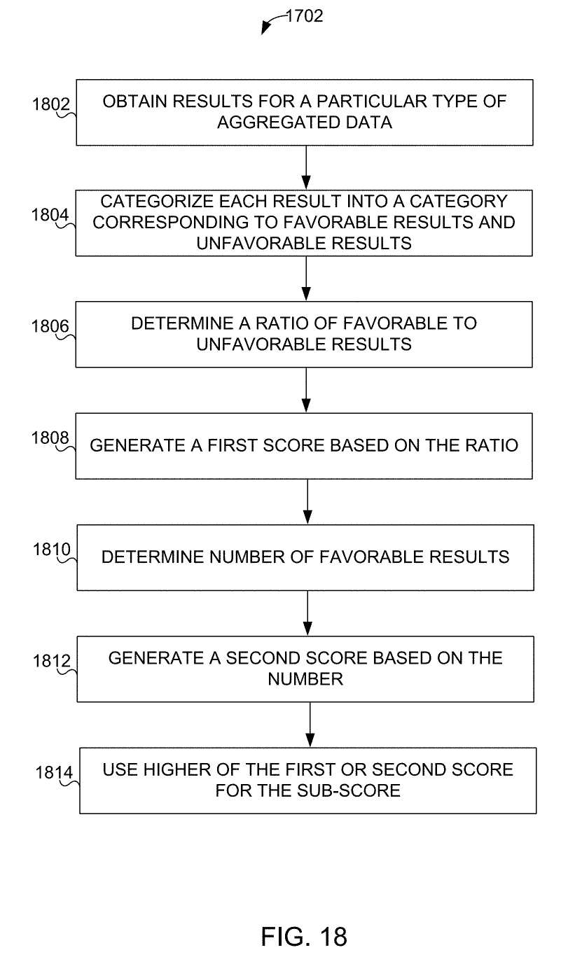

In an operation 1702, process 1700 may include generating a sub-score for a particular type of aggregated data. The different types of aggregated data may include, without limitation, polling data (e.g., from polling system 101), social media content (e.g., from social media platforms 120), news or regular media content (e.g., from content sites 130), and/or other data. Process 1800 discussed below with reference to FIG. 18 illustrates an example of generating such a sub-score.

In an operation 1704, process 1700 may include applying any weight to the sub-score. For example, the sub-score may be weighted to reflect a relative level of importance to the sub-score.

In an operation 1706, process 1700 may include determining whether additional types of aggregated data are to be analyzed. If yes, then processing may return to operation 1702 to generate a sub-score for the a remaining type of aggregated data. If no, then in an operation 1708, process 1700 may include generating a brand score based on the sub-scores. If only one type of aggregated data (e.g., its corresponding sub-score) is used, then the sub-score may be used as the brand score. Otherwise, a brand score may be based on a cumulative value (e.g., average, weighted average, median, etc.) based on the sub-scores.

FIG. 18 illustrates a flow diagram of a process 1800 for generating a sub-score for a type of aggregated data used in a brand score, according to an implementation of the invention.

In an operation 1802, process 1800 may include obtaining results for a particular type of aggregated data. The results may, for example, be responses to poll questions for polling data, social media content posts for social media data, news reports and other information for regular media data, and/or other types of results.

In an operation 1804, process 1800 may include categorizing each result. For example a category may relate to whether or not the result indicates a favorable or unfavorable opinion of the source of the result (e.g., the source being a poll respondent for poll data, a social media user for a social media content post, a reporter's or general public's view for a news item, etc.). Other types of categories may be used; “favorable” and “unfavorable” are used by example and not limitation.

In an operation 1806, process 1800 may include determining a ratio of favorable to unfavorable results. In an operation 1808, process 1800 may include generating a first score based on the ratio. In an operation 1810, process 1800 may include determining an overall number of favorable results. For example, the overall number may ignore any unfavorable results.

In an operation 1812, process 1800 may include generating a second score based on the number. In an operation 1814, process 1800 may include using the higher of the first or second score, and returning (e.g., to process 1700) the higher of the first or second score.

End User Devices 140

End user device 140 may be configured as a personal computer (e.g., a desktop computer, a laptop computer, etc.), a smartphone, a tablet computing device, and/or other device that can be programmed to interface with polling analytics system 102. Although not illustrated in FIG. 1, end user devices 140 may include one or more physical processors programmed by computer program instructions.

Although illustrated in FIG. 1 as a single component, computer system 110 and end user device 140 may each include a plurality of individual components (e.g., computer devices) each programmed with at least some of the functions described herein. In this manner, some components of computer system 110 and/or end user device 140 may perform some functions while other components may perform other functions, as would be appreciated. The one or more processors 212 may each include one or more physical processors that are programmed by computer program instructions. The various instructions described herein are exemplary only. Other configurations and numbers of instructions may be used, so long as the processor(s) 212 are programmed to perform the functions described herein.

Furthermore, it should be appreciated that although the various instructions are illustrated in FIG. 1 as being co-located within a single processing unit, in implementations in which processor(s) 212 includes multiple processing units, one or more instructions may be executed remotely from the other instructions.

The description of the functionality provided by the different instructions described herein is for illustrative purposes, and is not intended to be limiting, as any of instructions may provide more or less functionality than is described. For example, one or more of the instructions may be eliminated, and some or all of its functionality may be provided by other ones of the instructions. As another example, processor(s) 212 may be programmed by one or more additional instructions that may perform some or all of the functionality attributed herein to one of the instructions.

The various instructions described herein may be stored in a storage device 214, which may comprise random access memory (RAM), read only memory (ROM), and/or other memory. The storage device may store the computer program instructions (e.g., the aforementioned instructions) to be executed by processor 212 as well as data that may be manipulated by processor 212. The storage device may comprise floppy disks, hard disks, optical disks, tapes, or other storage media for storing computer-executable instructions and/or data.

The various databases 114 described herein may be, include, or interface to, for example, an Oracle™ relational database sold commercially by Oracle Corporation. Other databases, such as Informix™, DB2 (Database 2) or other data storage, including file-based, or query formats, platforms, or resources such as OLAP (On Line Analytical Processing), SQL (Structured Query Language), a SAN (storage area network), Microsoft Access™ or others may also be used, incorporated, or accessed. The database may comprise one or more such databases that reside in one or more physical devices and in one or more physical locations. The database may store a plurality of types of data and/or files and associated data or file descriptions, administrative information, or any other data.

The various components illustrated in FIG. 1 may be coupled to at least one other component via a network, which may include any one or more of, for instance, the Internet, an intranet, a PAN (Personal Area Network), a LAN (Local Area Network), a WAN (Wide Area Network), a SAN (Storage Area Network), a MAN (Metropolitan Area Network), a wireless network, a cellular communications network, a Public Switched Telephone Network, and/or other network. In FIG. 1, as well as in other drawing Figures, different numbers of entities than those depicted may be used. Furthermore, according to various implementations, the components described herein may be implemented in hardware and/or software that configure hardware.

The various processing operations and/or data flows depicted in FIG. 3 (and in the other drawing figures) are described in greater detail herein. The described operations may be accomplished using some or all of the system components described in detail above and, in some implementations, various operations may be performed in different sequences and various operations may be omitted. Additional operations may be performed along with some or all of the operations shown in the depicted flow diagrams. One or more operations may be performed simultaneously. Accordingly, the operations as illustrated (and described in greater detail below) are exemplary by nature and, as such, should not be viewed as limiting.

Other implementations, uses and advantages of the invention will be apparent to those skilled in the art from consideration of the specification and practice of the invention disclosed herein. The specification should be considered exemplary only, and the scope of the invention is accordingly intended to be limited only by the following claims.

What is claimed is:

1. A system for aggregating networked data and polling data relating to an entity to generate an entity score that reflects sentiment of users regarding the entity, the system comprising:
a computer system comprising one or more physical processors programmed by computer program instructions to:
obtain poll result data relating to the entity, the poll result data including at least a first poll response that indicates a first user sentiment of a first user regarding the entity and at least a second poll response that indicates a second user sentiment of a second user regarding the entity;
generate a poll result sub-score for the entity based on the poll result data;
obtain one or more social media content items from one or more social media platforms, wherein the one or more social media content items were posted to the one or more social media platforms and relate to the entity;
generate a social media sub-score for the entity based on the one or more social media content items; and
generate an entity score for the entity based on the poll result sub-score and the social media sub-score.

2. The system of claim 1, wherein to generate the social media sub-score, the computer system is further programmed to:
parse the one or more social media content items to electronically read one or more words or phrases from the one or more social media content items;
identify a sentiment for the one or more words or phrases based on a predefined dictionary that maps words or phrases to at least positive, negative, or neutral values, wherein the social media sub-score is generated based on the sentiment for each of the one or more words or phrases.

3. The system of claim 2, wherein to identify the sentiment, the computer system is further programmed to:
count a number of the one or more words or phrases that are associated with a positive value and a number of the one or more words or phrases that are associated with a negative value, wherein the sentiment is based on the number of the one or more words or phrases that are associated with a positive value and the number of the one or more words or phrases that are associated with a negative value.

4. The system of claim 1, wherein the computer system is further programmed to:
obtain, via an application programming interface, one or more news items from a news feed relating to the entity;
parse the one or more news items to electronically read one or more words or phrases from the one or more news items;
identify a sentiment for the one or more words or phrases based on a predefined dictionary that maps words or phrases to at least positive, negative, or neutral values;
generate a news sub-score based on the sentiment for the one or more words or phrases from the one or more news items, wherein the entity score is based further on the news sub-score.

5. The system of claim 4, wherein to identify the sentiment, the computer system is further programmed to:
count a number of the one or more words or phrases that are associated with a positive value and a number of the one or more words or phrases that are associated with a negative value, wherein the sentiment is based on the number of the one or more words or phrases that are associated with a positive value and the number of the one or more words or phrases that are associated with a negative value.

6. The system of claim 1, wherein the first poll response comprises one of a predefined number of closed-ended poll responses that was available to the first user.

7. The system of claim 1, wherein the entity score is obtained from poll result data and social media associated with a first time period, and wherein the computer system is further programmed to:
generate a plot of the entity score in association with the first time period, and other entity scores for the entity in association with other time periods, the other entity scores including at least a second entity score for a second time period;
count a first number of social media content items relating the entity and posted within the first time period;
count a second number of social media content items relating the entity and posted within the second time period;
overlay the first number and the second number onto the plot of the entity score and the second entity score; and
generate a graphical display based on the overlay and the plot of the entity score and the second entity score.

8. The system of claim 1, wherein the entity score relates to a brand score that represents a perception of the entity.

9. The system of claim 8, wherein the computer system is further programmed to:
convert the entity score to an alphabetic score.

10. The system of claim 1, wherein the computer system is further programmed to:
count a first number of poll responses that are associated with a favorable category of responses for the entity;
count a second number of poll responses that are associated with an unfavorable category of responses for the entity; and
determine a ratio based on the first number and the second number, wherein the entity score is based further on the ratio.

11. A computer-implemented method for aggregating networked data and polling data relating to an entity to generate an entity score that reflects sentiment of users regarding the entity, the method being implemented by a computer system having one or more physical processors programmed by computer program instructions to perform the method the method comprising:
obtaining, by the computer system, poll result data relating to the entity, the poll result data including at least a first poll response that indicates a first user sentiment of a first user regarding the entity and at least a second poll response that indicates a second user sentiment of a second user regarding the entity;
generating, by the computer system, a poll result sub-score for the entity based on the poll result data;
obtaining, by the computer system, one or more social media content items from one or more social media platforms, wherein the one or more social media content items were posted to the one or more social media platforms and relate to the entity;
generating, by the computer system, a social media sub-score for the entity based on the one or more social media content items; and
generating, by the computer system, an entity score for the entity based on the poll result sub-score and the social media sub-score.

12. The method of claim 11, wherein generating the social media sub-score comprises:
parsing, by the computer system, the one or more social media content items to electronically read one or more words or phrases from the one or more social media content items;
identifying, by the computer system, a sentiment for the one or more words or phrases based on a predefined dictionary that maps words or phrases to at least positive, negative, or neutral values, wherein the social media sub-score is generated based on the sentiment for each of the one or more words or phrases.

13. The method of claim 12, wherein identifying the sentiment comprises:
counting, by the computer system, a number of the one or more words or phrases that are associated with a positive value and a number of the one or more words or phrases that are associated with a negative value, wherein the sentiment is based on the number of the one or more words or phrases that are associated with a positive value and the number of the one or more words or phrases that are associated with a negative value.

14. The method of claim 1, the method further comprising:
obtaining, by the computer system, via an application programming interface, one or more news items from a news feed relating to the entity;
parsing, by the computer system, the one or more news items to electronically read one or more words or phrases from the one or more news items;
identifying, by the computer system, a sentiment for the one or more words or phrases based on a predefined dictionary that maps words or phrases to at least positive, negative, or neutral values;
generating, by the computer system, a news sub-score based on the sentiment for the one or more words or phrases from the one or more news items, wherein the entity score is based further on the news sub-score.

15. The method of claim 14, wherein identifying the sentiment comprises:
counting, by the computer system, a number of the one or more words or phrases that are associated with a positive value and a number of the one or more words or phrases that are associated with a negative value, wherein the sentiment is based on the number of the one or more words or phrases that are associated with a positive value and the number of the one or more words or phrases that are associated with a negative value.

16. The method of claim 11, wherein the first poll response comprises one of a predefined number of closed-ended poll responses that was available to the first user.

17. The method of claim 11, wherein the entity score is obtained from poll result data and social media associated with a first time period, and wherein the method further comprises:
generating, by the computer system, a plot of the entity score in association with the first time period, and other entity scores for the entity in association with other time periods, the other entity scores including at least a second entity score for a second time period;
counting, by the computer system, a first number of social media content items relating the entity and posted within the first time period;
counting, by the computer system, a second number of social media content items relating the entity and posted within the second time period;
overlaying, by the computer system, the first number and the second number onto the plot of the entity score and the second entity score; and
generating, by the computer system, a graphical display based on the overlay and the plot of the entity score and the second entity score.

18. The method of claim 11, wherein the entity score relates to a brand score that represents a perception of the entity.

19. The method of claim 18, wherein the method further comprises:
converting, by the computer system, the entity score to an alphabetic score.

20. The method of claim 18, wherein the method further comprises:
counting, by the computer system, a first number of poll responses that are associated with a favorable category of responses for the entity;
counting, by the computer system, a second number of poll responses that are associated with an unfavorable category of responses for the entity; and
determining, by the computer system, a ratio based on the first number and the second number, wherein the entity score is based further on the ratio.
